(19) United States
(12) Patent Application Publication
(10) Pub. No.: US 2021/0162778 A1
(43) Pub. Date: Jun. 3, 2021

(54) INK JET RECORDING METHOD AND INK JET RECORDING APPARATUS

(71) Applicant: Seiko Epson Corporation, Tokyo (JP)

(72) Inventor: Yuta ASAKAWA, Azumino (JP)

(21) Appl. No.: 17/104,210

(22) Filed: Nov. 25, 2020

(30) Foreign Application Priority Data
Nov. 29, 2019 (JP) 2019-216582

(51) Int. Cl. B41J 11/00; B41J 2/21; C09D 11/12; C09D 11/30; B41M 7/00

(52) U.S. Cl. CPC B41J 11/002; B41J 2/2107; B41M 7/009; C09D 11/30; C09D 11/12

(57) ABSTRACT

An ink jet recording method includes an ink attachment step, in which a water-based ink composition is ejected from an ink jet head and attached to a recording medium, and a heating step, in which the recording medium is heated, after the ink attachment step. The water-based ink composition contains resin particles and wax. The resin particles have a volume-average diameter A of 90.0 nm or more, and the ratio between the volume-average diameter A of the resin particles and the volume-average diameter B of the particles of the wax (B/A) is 0.7 or more. The heating step is through irradiation with infrared light.

The present application is based on, and claims priority from JP Application Serial Number 2019-216582, filed Nov. 29, 2019, the disclosure of which is hereby incorporated by reference herein in its entirety.

### BACKGROUND

### 1. Technical Field

The present disclosure relates to an ink jet recording method and an ink jet recording apparatus.

### 2. Related Art

Ink jet recording, a known technology in which tiny droplets of ink(s) are ejected from nozzles of an ink jet head of an ink jet recording apparatus to record an image on a recording medium, is under study for use in the fields of sign printing and high-speed label printing. When ink jet recording is applied to record an image on a recording medium that absorbs little ink (e.g., art paper or coated paper) or no ink (e.g., plastic film), a class of inks that can be used is water-based resin ink compositions, which are water-based ink compositions containing a resin emulsion (hereinafter also simply referred to as “water-based ink compositions” or “water-based inks”). Their advantages include friendliness to the global environment, safety to humans, etc.

A known technique in the production of a water-based ink is to add wax, besides resin microparticles as a fixing resin, to improve the abrasion resistance of the resulting recordings. For example, JP-A-2018-162341 discloses a water-based ink that contains a polyolefin wax, dispersed resin, water, and a surfactant. The surfactant content and the total amount of the dispersed resin and polyolefin wax are designed to be within particular ranges. According to JP-A-2018-162341, an appropriate amount of surfactant in a water-based ink improves fixation, abrasion resistance, and image quality.

The inventor, however, has found through research that the abrasion resistance of an image formed with a water-based ink is influenced by the diameter of resin particles and wax particles contained.

Simply adjusting the diameter of the resin particles and/or wax particles is not enough because strong abrasion resistance needs to be achieved without compromising the recovery of clogged nozzles of the ink jet head.

### SUMMARY

(1) A form of an ink jet recording method according to an aspect of the present disclosure includes an ink attachment step, in which a water-based ink composition is ejected from an ink jet head and attached to a recording medium, and a heating step, in which the recording medium is heated, after the ink attachment step. The water-based ink composition contains resin particles and wax. The resin particles have a volume-average diameter A of 90.0 nm or more, and a ratio between the volume-average diameter A of the resin particles and a volume-average diameter B of particles of the wax, B/A, is 0.7 or more. The heating step is through irradiation with infrared light.

(2) In form (1) above, the volume-average diameter A of the resin particles may be 150.0 nm or more and 300.0 nm or less, and the volume-average diameter B of the particles of the wax may be 60.0 nm or more and 300.0 nm or less.

(3) In form (1) or (2) above, the ratio B/A may be 0.7 or more and 2.5 or less.

(4) In any of forms (1) to (3) above, the resin particles may have a glass transition temperature of 60.0° C. or more and 90.0° C. or less.

(5) In any of forms (1) to (4) above, the wax may have a melting point of 105.0° C. or more and 140.0° C. or less.

(6) In any of forms (1) to (5) above, in the heating step, the recording medium may be heated to a surface temperature equal to or higher than a glass transition temperature of the resin particles and lower than a melting point of the wax.

(7) In any of forms (1) to (6) above, the wax may be a polyolefin wax.

(8) In any of forms (1) to (7) above, the heating step may include moving air present around the recording medium using an air-blow mechanism.

(9) In any of forms (1) to (8), the resin particles may be of a resin selected from acrylic resins, urethane resins, ester resins, and vinyl chloride resins.

(10) In any of forms (1) to (9), the resin particles may represent 0.5% by mass or more and 15.0% by mass or less of a total mass of the ink composition, and the wax may represent 0.1% by mass or more and 2.0% by mass or less of the total mass of the ink composition.

(11) In any of forms (1) to (10) above, in the heating step, a portion of the recording medium may have a surface temperature of 80.0° C. or above for a period of 20.0 seconds or more and 120.0 seconds or less.

(12) In any of forms (1) to (11) above, the recording method may further include attaching a treatment liquid containing a flocculant to the recording medium.

(13) In any of forms (1) to (12) above, the wax may be a nonionically dispersed wax or wax dispersed with a nonionic emulsifier.

(14) In any of forms (1) to (13) above, the water-based ink composition may contain an organic solvent having a normal boiling point of 180.0° C. or more and 280.0° C. or less, with the organic solvent representing 20.0% by mass or more and 35.0% by mass or less.

(15) A form of an ink jet recording apparatus according to an aspect of the present disclosure is configured to perform the ink jet recording method according to any of forms (1) to (14) above.

### BRIEF DESCRIPTION OF THE DRAWINGS

FIG. 1 is an outline illustration of an example of an ink jet recording apparatus according to an embodiment.

FIG. 2 is an outline illustration of the carriage and related components of an example of an ink jet recording apparatus according to an embodiment.

FIG. 3 is a schematic view of a cross-section of an infrared heater.

FIG. 4 is a block diagram for an example of an ink jet recording apparatus according to an embodiment.

FIG. 5 is an outline cross-sectional diagram schematically illustrating part of a line recording apparatus.

### DESCRIPTION OF EXEMPLARY EMBODIMENTS

The following describes embodiments of the present disclosure. The following embodiments are descriptions of examples of the disclosure. The disclosure is never limited to these embodiments and includes variations implemented within the gist of the disclosure. Not all the configurations described below are essential for the disclosure.

### 1. INK JET RECORDING METHOD

An ink jet recording method according to this embodiment includes an ink attachment step, in which a water-based ink composition is ejected from an ink jet head and attached to a recording medium, and a heating step, in which the recording medium is heated, after the ink attachment step.

### 1.1. Ink Attachment Step

A water-based ink composition is ejected from an ink jet head and attached to a recording medium. The following describes the water-based ink composition first, then the ink jet head, and then the recording medium.

### 1.1.1. Water-Based Ink Composition

The water-based ink composition contains resin particles, wax, and water.

### 1.1.1.1. Resin Particles

The water-based ink composition according to this embodiment contains resin particles. The resin particles function as a fixing resin, or to improve the adhesion and abrasion resistance of the components of the water-based ink composition attached to the recording medium.

Examples of resin particles include particles of resins such as urethane resins, acrylic resins, ester resins, fluorene resins, polyolefin resins, rosin-modified resins, terpene resins, polyester resins, polyamide resins, epoxy resins, vinyl chloride resins, and ethylene vinyl acetate resins. Particles of these types of resins are often handled in emulsion form, but the resin particles in this embodiment may be a powder. One type of resin particles alone or two or more in combination can be used.

Resins that have a urethane bond are collectively referred to as urethane resins. They also include resins that contain a non-urethane bond, such as polyether urethane resins, which contain an ether bond in their backbone, polyester urethane resins, which contain an ester bond in their backbone, and polycarbonate urethane resins, which contain a carbonate bond in their backbone. Commercially available urethane resins can also be used. For example, one or more may be selected from commercially available urethane resins such as SUPERFLEX 210, 460, 460s, 840, and E-4000 (trade names, DKS Co., Ltd.), RESAMINE D-1060, D-2020, D-4080, D-4200, D-6300, and D-6455 (trade names, Dainichiseika Color & Chemicals Mfg. Co., Ltd.), Takelac WS-6020, WS-6021, and W-512-A-6 (trade names, Mitsui Chemicals Polyurethanes, Inc.), Sancure 2710 (trade name, LUBRIZOL), and PERMARIN UA-150 (trade name, Sanyo Chemical Industries).

Polymers obtained by polymerizing at least an acrylic monomer, such as (meth)acrylic acid or a (meth)acrylate, are collectively referred to as acrylic resins. Examples include resins obtained from acrylic monomers and copolymers of acrylic and other monomers. Examples of the latter include acryl-vinyl resins, which are copolymers of acrylic and vinyl monomers, such as copolymers of an acrylic monomer and styrene or a similar vinyl monomer. Acrylamide and acrylonitrile, for example, are also acrylic monomers that can be used.

Commercially available resin emulsions made with an acrylic resin can also be used. For example, one or more may be selected from commercially available resin emulsions such as FK-854, Mowinyl 952B and 718A (trade names, Japan Coating Resin), Nipol LX852 and LX874 (trade names, Zeon), POLYSOL AT860 (trade name, Showa Denko K.K.), and VONCOAT AN-1190S, YG-651, AC-501, AN-1170, and 4001 (trade names, DIC).

As mentioned above, the category of acrylic resins includes styrene-acrylic resins. The expression (meth)acrylic herein refers to at least one of acrylic and methacrylic.

Styrene-acrylic resins are copolymers of the styrene monomer and an acrylic monomer. Examples include styrene-acrylic acid copolymers, styrene-methacrylic acid copolymers, and styrene-o-methylstyrene-acrylic acid copolymers. Commercially available styrene-acrylic resins can also be used. Examples include Joncryl 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (trade names, BASF) and Mowinyl 966A and 975N (trade names, Japan Coating Resin).

The category of vinyl chloride resins includes vinyl chloride-vinyl acetate copolymers. Examples of ester resins include polymers containing an acrylate as a monomer unit, such as styrene-methacrylic acid-acrylate copolymers, styrene-α-methylstyrene-acrylic acid copolymers, and styrene-α-methylstyrene-acrylic acid-acrylate copolymers.

Polyolefin resins are resins that have an olefin, such as ethylene, propylene, or butylene, as their structural backbone, and suitable one(s) can be selected from known ones. Commercially available polyolefin resins can be used. For example, one or more may be selected from commercially available olefin resins such as ARROWBASE CB-1200 and CD-1200 (trade names, UNITIKA Ltd.).

The resin particles may be supplied in emulsion form. Examples of commercially available resin emulsions include MICROGEL E-1002 and E-5002 (trade names, Nippon Paint, styrene-acrylic resin emulsions), VONCOAT AN-1190S, YG-651, AC-501, AN-1170, 4001, and 5454 (trade names, DIC, styrene-acrylic resin emulsions), POLYSOL AM-710, AM-920, AM-2300, AP-4735, AT-860, and PSASE-4210E (acrylic resin emulsions), POLYSOL AP-7020 (styrene-acrylic resin emulsion), POLYSOL SH-502 (vinyl acetate resin emulsion), POLYSOL AD-13, AD-2, AD-10, AD-96, AD-17, and AD-70 (ethylene-vinyl acetate resin emulsions), POLYSOL PSASE-6010 (ethylene-vinyl acetate resin emulsion) (trade names, Showa Denko), POLYSOL SAE1014 (trade name, Zeon, a styrene-acrylic resin emulsion), SAIVINOL SK-200 (trade name, Saiden Chemical Industry, an acrylic resin emulsion), AE-120A (trade name, JSR, an acrylic resin emulsion), AE373D (trade name, Emulsion Technology, a carboxy-modified styrene-acrylic resin emulsion), SEIKADYNE 1900W (trade name, Dainichiseika Color & Chemicals Mfg., an ethylene-vinyl acetate resin emulsion), VINYBLAN 2682 (acrylic resin emulsion), VINYBLAN 2886 (vinyl acetate-acrylic resin emulsion), VINYBLAN 5202 (acetic acid-acrylic resin emulsion) (trade names, Nissin Chemical Industry), VINYBLAN 700 and 2586 (trade names, Nissin Chemical Industry), elitel KA-5071S, KT-8803, KT-9204, KT-8701, KT-8904, and KT-0507 (trade names, Unitika, polyester resin emulsions), Hytec SN-2002 (trade name, Toho Chemical, a polyester resin emulsion), Takelac W-6020, W-635, W-6061, W-605, W-635, and W-6021 (trade names, Mitsui Chemicals Polyurethanes, urethane resin emulsions), SUPERFLEX 870, 800, 150, 420, 460, 470, 610, 620, and 700 (trade names, DKS, urethane resin emulsions), PERMARIN UA-150 (trade name, Sanyo Chemical Industries, Ltd., a urethane resin emulsion), Sancure 2710 (trade name, Lubrizol Japan, a urethane resin emulsion), NeoRez R-9660, R-9637, and R-940 (trade names, Kusumoto Chemicals Ltd., urethane resin emulsions), ADEKA BONTIGHTER HUX-380 and 290K (trade names, ADEKA Corporation, urethane resin emulsions), Mowinyl 966A and Mowinyl 7320 (trade names, Japan Coating Resin), Joncryl 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (trade names, BASF), NK Binder R-5HN (trade name, Shin-Nakamura Chemical Co., Ltd.), HYDRAN WLS-210 (trade name, DIC Corporation, a non-crosslinked polyurethane), and Joncryl 7610 (trade name, BASF).

Preferably, the resin particles are of one or more resins selected from urethane resins, acrylic resins, ester resins, and vinyl chloride resins. These types of resins are better than others in adhesion and abrasion resistance. Particles of urethane and/or acrylic resin(s) are more preferred. They help further improve the adhesion and abrasion resistance of the components of the water-based ink composition attached to the recording medium.

Preferably, the percentage of the resin particles in the water-based ink composition is 0.1% by mass or more and 20% by mass or less on a solids basis, more preferably 0.5% by mass or more and 15.0% by mass or less, even more preferably 1.0% by mass or more and 15.0% by mass or less, still more preferably 2.0% by mass or more and 10.0% by mass or less of the total mass of the water-based ink composition.

The resin particles contained in the water-based ink composition according to this embodiment have an average diameter on a volume basis (D50) (also referred to as volume-average diameter) of 90.0 nm or more. By virtue of having a volume-average diameter of 90.0 nm or more, the resin particles in the water-based ink composition do not easily fuse together inside the nozzles of the ink jet head, thereby helping reduce the clogging of the ink jet head. In this regard, it is preferred that the volume-average diameter of the resin particles be 100.0 nm or more, more preferably 150.0 nm or more, even more preferably 180.0 nm or more. As for the upper limit, the volume-average diameter of the resin particles is preferably 300 nm or less, more preferably 250.0 nm or less, even more preferably 220.0 nm or less, still more preferably 150 nm or less. This helps form a good coating on the recording medium by melting and deforming the resin particles in secondary heating.

The volume-average diameter of the resin particles and that of the particles of the wax (described below) can be controlled by, for example, the amount or type of emulsifier used to disperse these particles. When emulsion polymerization is used to obtain the resin particles and the wax, the volume-average diameters can be controlled by the amount or type of emulsifier used in the emulsion polymerization. In emulsion polymerization, polymerization is concurrent with emulsification (dispersion). The amount and type of emulsifier used determine the degree of dispersion of the particles of the polymer and therefore can be used to control the average diameter. Polymerization or dispersion conditions, such as the stirring speed, temperature, cooling rate, and pressure, can also be customized to control the volume-average diameters. Filtering the resulting liquid dispersion through a filter having pores of appropriate size is another way to control the volume-average diameters. The manufacturer only needs to obtain resin particles and particles of wax having the desired volume-average diameter by taking any such approach.

The volume-average diameter of the resin particles and that of the particles of the wax (described below) can be measured using an instrument that measures the size distribution of particles based on dynamic light scattering. An example of such an instrument is a particle size distribution analyzer based on dynamic light scattering (e.g., Microtrac UPA, Nikkiso Co., Ltd.).

Preferably, the resin(s) forming the resin particles has a glass transition temperature lower than 100.0° C. This helps the resin particles form film on the recording medium. The film firmly adheres to the recording medium, thereby providing better abrasion resistance. More preferably, the glass transition temperature is 50° C. or more and less than 100° C., even more preferably 60.0° C. or more and 90.0° C. or less. The glass transition temperature (Tg) of the resin(s) forming the resin particles and the melting point of the wax can be determined as usual, for example using differential scanning calorimetry (DSC).

The glass transition point of the resin particles can be controlled by customizing the species or proportions of the monomer(s) used when the resin(s) is produced by polymerization.

Preferably, the resin(s) forming the resin particles has a weight-average molecular weight of 10,000 or more, more preferably 30,000 or more, even more preferably 50,000 or more. There is no upper limit, but preferably the weight-average molecular weight is 150,000 or less for example, more preferably 100,000 or less.

### 1.1.1.2. Wax

The water-based ink composition according to this embodiment contains wax. Examples of waxes that can be used include vegetable/animal waxes, such as carnauba wax, candelilla wax, beeswax, rice bran wax, and lanolin; petroleum waxes, such as paraffin waxes, microcrystalline waxes, polyethylene waxes, oxidized polyethylene waxes, polypropylene waxes, and petrolatum; mineral waxes, such as montan wax and ozokerite; and synthetic waxes, such as carbon waxes, hoechst waxes, polyolefin waxes, and stearic acid amide; and natural/synthetic wax emulsions, such as o6-olefin-maleic anhydride copolymers, and compound waxes. One such wax alone or a mixture of two or more can be used. Of these, polyolefin waxes (in particular, polyethylene wax and polypropylene wax) are particularly preferred because they more effective than other types of waxes in improving the abrasion resistance of the image.

It is also possible to use commercially available wax(es) directly. Examples include NOPCOTE PEM-17 (trade name, San Nopco Ltd.), CHEMIPEARL W4005 (trade name, Mitsui Chemicals, Inc.), and AQUACER 515, 539, and 593 (trade names, BYK Japan K.K.).

Preferably, the melting point of the wax is 100.0° C. or more and 180.0° C. or less. This reduces the risk that the wax will melt during the heating step in the recording method to such an extent that it will lose its performance. More preferably, the melting point of the wax is 105.0° C. or more and 140° C. or less, even more preferably 110.0° C. or more and 135.0° C. or less.

Preferably, the melting point of the wax is higher than the aforementioned glass transition temperature of the resin particles. This ensures that the resin particles can be properly processed into film without excessive melting of the wax by setting the temperature of secondary heating on the recording medium between the melting point of the wax and the glass transition temperature of the resin particles. It is better to avoid excessive melting of the wax, because it helps prevent the wax from forming film. The difference between the melting point of the wax and the glass transition temperature of the resin particles is 20.0° C. or more for example, preferably 40° C. or more, more preferably 50.0° C. or more, even more preferably 80.0° C. or more. There is no upper limit, but preferably the difference is 90° C. or less for example, more preferably 70° C. or less, even more preferably 60° C. or less, still more preferably 50° C. or less.

Like the glass transition point of the resin particles, the melting point of the wax can be controlled by customizing the species or proportions of the monomer(s) used when the wax is produced by polymerization. The weight-average molecular weight of the wax can also be used to control the melting point.

The wax may be supplied in emulsion or suspension form. Preferably, the wax content is 0.05% by mass or more and 5.0% by mass or less on a solids basis, more preferably 0.1% by mass or more and 5.0% by mass or less, even more preferably 0.1% by mass or more and 2.0% by mass or less of the total mass of the water-based ink composition. Wax present in any such amount gives strong abrasion resistance to the recorded image.

Preferably, the particles of the wax contained in the water-based ink composition according to this embodiment have a volume-average diameter (D50) of 60.0 nm or more. When its particles have a volume-average diameter of 60.0 nm or more, the wax gives a sufficient degree of abrasion resistance to the resulting image. In this regard, it is more preferred that the volume-average diameter of the particles of the wax be 80.0 nm or more, even more preferably 150.0 nm or more, still more preferably 200.0 nm or more. As for the upper limit, the volume-average diameter of the particles of the wax is 300 nm or less for example, preferably 240.0 nm or less, more preferably 200.0 nm or less. This helps reduce the clogging of the ink jet head.

Preferably, the wax has a weight-average molecular weight of less than 10,000. It is more preferred that the weight-average molecular weight of the wax be on the order of thousands, such as 8,000 or less, 6,000 or less, or 4,000 or less. As for the lower limit, the weight-average molecular weight of the wax is preferably 1,000 or more. The distinction between resins and waxes may be based on this molecular weight.

Waxes that can be used include nonionically dispersed waxes, anionically dispersed waxes, cationically dispersed waxes, etc. A nonionically dispersed wax represents wax dispersed using a nonionic emulsifier or a wax that is nonionic in itself and has dispersed by itself without an emulsifier. When a nonionically dispersed wax is in a liquid dispersion, the liquid dispersion is anionic.

An anionically dispersed wax represents wax dispersed using an anionic emulsifier or a wax that is anionic in itself and has dispersed by itself without an emulsifier. When an anionically dispersed wax is in a liquid dispersion, the liquid dispersion is anionic.

A cationically dispersed wax represents wax dispersed using a cationic emulsifier or a wax that is cationic in itself and has dispersed by itself without an emulsifier. When a cationically dispersed wax is in a liquid dispersion, the liquid dispersion is cationic.

Of these, anionically dispersed waxes and nonionically dispersed waxes are preferred because they impart high storage stability, for example, to the ink. More preferably, the wax is a nonionically dispersed wax. This makes the recording better in abrasion resistance when a treatment liquid is used.

### 1.1.1.3. Diameters of the Resin Particles and the Particles of the Wax

In the water-based ink composition according to this embodiment, the ratio between the volume-average diameter A of the resin particles and the volume-average diameter B of the particles of the wax (B/A) is 0.7 or more. Preferably, the ratio is 0.9 or more, more preferably 1.0 or more, even more preferably 1.5 or more. As for the upper limit, the ratio is 5.0 or less for example, preferably 3.0 or less, more preferably 2.5 or less, even more preferably 2.0 or less.

More preferably, the water-based ink composition is designed with resin particles having a volume-average diameter A of 150.0 nm or more and 300.0 nm or less and a wax whose particles have a volume-average diameter B of 60.0 nm or more and 300.0 nm or less. It is particularly preferred that the volume-average diameters of the resin particles and the particles of the wax be in these ranges when the ratio (B/A) is 0.7 or more and 2.5 or less.

### 1.1.1.4. Water

The water-based ink composition contains water. The water is the primary carrier in the water-based ink composition and is a component that evaporates away as the ink composition dries. Preferably, the water is of a type from which ionic impurities have been removed to the lowest possible levels, such as deionized water, ultrafiltered water, reverse osmosis water, distilled water, or any other type of purified or ultrapure water. The use of sterilized water, for example sterilized by ultraviolet irradiation or adding hydrogen peroxide, is preferred because it helps control the development of molds and bacteria when the ink is stored long.

The water-based ink composition is a composition that contains 45% by mass or more water as its primary solvent. The water-based ink composition is therefore a so-called water-based ink. A water-based ink is substantially odorless and, by virtue of 45% by mass or more of it being water, offers the advantage of being environmentally-friendly.

### 1.1.1.5. Extra Ingredients

The water-based ink composition according to this embodiment may contain the following ingredients.

### Organic Solvent

The water-based ink composition according to this embodiment may contain an organic solvent. Using an organic solvent can help, for example, accelerate the drying of the recording and enhance the fastness of the image. An organic solvent also improves the ejection stability of the water-based ink composition. Water-miscible organic solvents are preferred.

A function of the organic solvent is to improve the wettability of the water-based ink composition on the recording medium and to enhance the water retention of the water-based ink composition. The organic solvent reduces the surface tension of the water-based ink composition, thereby helping the ink composition leave nozzles and fly smoothly as droplets when ejected from the ink jet head. As a result, the ink droplets wet and spread over the recording medium better.

Examples of organic solvents include esters, alkylene glycol ethers, cyclic esters, nitrogen-containing solvents, and polyhydric alcohols. Examples of nitrogen-containing solvents include cyclic amides and acyclic amides. Examples of acyclic amides include alkoxyalkylamides.

Examples of esters include glycol monoacetates, such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxybutyl acetate, and glycol diesters, such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, diethylene glycol acetate butyrate, propylene glycol acetate propionate, propylene glycol acetate butyrate, dipropylene glycol acetate butyrate, and dipropylene glycol acetate propionate.

Examples of cyclic esters include cyclic esters (lactones) such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, and ε-decanolactone and compounds derived from such lactones by substituting hydrogen(s) in the methylene group next to the carbonyl group with a C1 to C4 alkyl group.

Examples of nitrogen-containing solvents include acyclic amides and cyclic amides. Examples of acyclic amides include alkoxyalkylamides.

Examples of alkoxyalkylamides include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-isopropoxy-N,N-dimethylpropionamide, 3-isopropoxy-N,N-diethylpropionamide, 3-isopropoxy-N,N-methylethylpropionamide, 3-tert-butoxy-N,N-dimethylpropionamide, 3-tert-butoxy-N,N-diethylpropionamide, and 3-tert-butoxy-N,N-methylethylpropionamide.

It is also preferred to use an alkoxyalkylamide, which is a type of acyclic amide and is represented by general formula (1) below.

R¹—O—CH₂CH₂—(C═O)—NR²R³ (1)

In formula (1) above, R¹ denotes a C1 to C4 alkyl group, and R² and R³ each independently denote a methyl or ethyl group. The “C1 to C4 alkyl group” can be a linear or branched alkyl group. To name a few, it can be a methyl, ethyl, n-propyl, isopropyl, n-butyl, sec-butyl, isobutyl, or tert-butyl group. One compound represented by formula (1) above may be used alone, or two or more may be used as a mixture.

Examples of cyclic amides include lactams, such as pyrrolidones including 2-pyrrolidone, 1-methyl-2-pyrrolidone, 1-ethyl-2-pyrrolidone, 1-propyl-2-pyrrolidone, and 1-butyl-2-pyrrolidone. These cyclic amides are advantageous in that with such an amide in the ink composition, the resin particles form film faster (described below). 2-Pyrrolidone is particularly preferred.

An alkylene glycol ether can be any monoether or diether of an alkylene glycol, preferably an alkyl ether. Specific examples include alkylene glycol monoalkyl ethers, such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, and tripropylene glycol monobutyl ether, and alkylene glycol dialkyl ethers, such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Preferably, the alkylene glycol as a component of the alkylene glycol ether is a C2 to C8, more preferably C2 to C6, even more preferably C2 to C4, in particular C2 or C3 alkylene glycol. There may be condensations between hydroxy groups of molecules of the alkylene glycol as a component of the alkylene glycol ether. The number of condensations is preferably from 1 to 4, more preferably from 1 to 3, even more preferably 2 or 3.

Preferably, the ether as a component of the alkylene glycol is an alkyl ether. The alkyl ether is preferably an ether of a C1 to C4 alkyl, more preferably an ether of a C2 to C4 alkyl.

Alkylene glycol ethers are advantageous in that they help the ink wet the recording medium well by virtue of their superior permeability. With an alkylene glycol ether, therefore, the resulting image is of high quality. In light of this, monoethers are particularly preferred.

Examples of polyhydric alcohols include 1,2-alkanediols (e.g., alkanediols such as ethylene glycol, propylene glycol (also known as propane-1,2-diol), 1,2-butanediol, 1,2-pentanediol, 1,2-hexanediol, 1,2-heptanediol, and 1,2-octanediol) and polyhydric alcohols other than 1,2-alkanediols (polyols) (e.g., ethylene glycol, propylene glycol, diethylene glycol, dipropylene glycol, 1,3-propanediol, 1,3-butanediol (also known as 1,3-butylene glycol), 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, trimethylolpropane, and glycerol).

Polyhydric alcohols can be divided into alkanediols and polyols.

An alkanediol in this context is a diol of a C5 or longer alkane. The alkane is preferably a C5 to C15, more preferably C6 to C10, even more preferably C6 to C8 alkane. 1,2-Alkanediols are preferred.

A polyol in this context is a polyol of a C4 or shorter alkane or a condensate formed by intermolecular condensation between hydroxy groups of a polyol of a C4 or shorter alkane. The alkane is preferably a C2 or C3 alkane. The number of hydroxy groups in the molecule of the polyol is 2 or more, preferably 5 or less, more preferably 3 or less. When the polyol is a condensate as described above, the number of intermolecular condensations is 2 or more, preferably 4 or less, more preferably 3 or less. One polyhydric alcohol alone or a mixture of two or more can be used.

Alkanediols and polyols can function primarily as penetration solvents and/or moisturizing solvents. Alkanediols, however, tend to behave more as penetration solvents, and polyols tend to behave more as moisturizing solvents.

Alkanediols are advantageous in that they help the ink wet and spread over the recording medium well by virtue of their strong tendency to behave as penetration solvents. With an alkanediol, therefore, the resulting image is of high quality.

Polyols help enhance water retention in particular, by virtue of their superb hydrophilicity. With a polyol, therefore, the ink composition is superior especially in preventing clogging. In particular, using a polyol having a normal boiling point of 280.0° C. or below also ensures the ink dries quickly, thereby making the recording highly robust.

The water-based ink composition may contain one such organic solvent as listed above alone or may contain two or more in combination. When two or more organic solvents are contained, the organic solvent content is the total percentage of them.

Preferably, the total percentage of organic solvents in the water-based ink composition is 40.0% by mass or less, more preferably 35.0% by mass or less, of the total amount of the water-based ink composition. As for the lower limit, the total percentage of organic solvents is preferably 10.0% by mass or more, more preferably 20.0% by mass or more, even more preferably 25.0% by mass or more.

Preferably, the organic solvent(s) contained in the water-based ink composition has a normal boiling point of 280.0° C. or below. More preferably, the normal boiling point is 150.0° C. or more and 280.0° C. or less, even more preferably 170.0° C. or more and 280.0° C. or less, still more preferably 180.0° C. or more and 280.0° C. or less, further preferably 190.0° C. or more and 270.0° C. or less, in particular 200.0° C. or more and 250.0° C. or less.

More preferably, the water-based ink composition contains organic solvent(s) having a normal boiling point of 180.0° C. or more and 280.0° C. or less in an amount of 20.0% by mass or more and 35.0% by mass or less, preferably 25.0% by mass or more and 30.0% by mass or less.

It is, moreover, preferred that the percentage of organic solvents having a normal boiling point exceeding 280.0° C. be 2.0% by mass or less, more preferably 1.5% by mass or less, even more preferably 1.0% by mass or less of the total amount of the water-based ink composition. The water-based ink composition may even be free of such organic solvents. That is, the percentage of organic solvents having a normal boiling point exceeding 280.0° C. may be 0.0% by mass. This ensures quick drying of the water-based ink composition attached to the recording medium, thereby helping improve the adhesion of the ink composition to the recording medium.

Examples of organic solvents having a normal boiling point exceeding 280.0° C. include glycerol and polyethylene glycol monomethyl ether.

### Colorant

The water-based ink composition may contain a colorant. Both pigments and dyes can be used. Examples of colorants that can be used include inorganic pigments including carbon black and titanium white, organic pigments, solvent dyes, acidic dyes, direct dyes, reactive dyes, basic dyes, disperse dyes, and sublimation dyes. In the water-based ink composition according this embodiment, the colorant may be dispersed with a dispersing resin.

Examples of inorganic pigments that can be used include carbon black (C.I. Pigment Black 7) pigments, such as furnace black, lamp black, acetylene black, and channel black, iron oxide, titanium oxide, zinc oxide, and silica.

Examples of organic pigments include quinacridone pigments, quinacridone quinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, isoindolinone pigments, azomethine pigments, and azo pigments.

Specific examples of organic pigments that can be used in the water-based ink composition include the following.

Examples of cyan pigments include C.I. Pigment Blue 1, 2, 3, 15:3, 15:4, 15:34, 16, 22, and 60 and C.I. Vat Blue 4 and 60. An example of a preferred cyan pigment is one or a mixture of two or more selected from the group consisting of C.I. Pigment Blue 15:3, 15:4, and 60.

Examples of magenta pigments include C.I. Pigment Red 5, 7, 12, 48 (Ca), 48 (Mn), 57 (Ca), 57:1, 112, 122, 123, 168, 184, and 202 and C.I. Pigment Violet 19. An example of a preferred magenta pigment is one or a mixture or solid solution of two or more selected from the group consisting of C.I. Pigment Red 122, 202, and 209 and C.I. Pigment Violet 19.

Examples of yellow pigments include C.I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, and 185. An example of a preferred yellow pigment is one or a mixture of two or more selected from the group consisting of C.I. Pigment Yellow 74, 109, 110, 128, and 138.

Pigments in other colors can also be used. Examples include orange and green pigments.

The pigments listed above are merely examples of suitable pigments and do not limit any aspect of the present disclosure. One or a mixture of two or more such pigments may be used, with or without dye(s).

A pigment may be dispersed with a dispersant selected from, for example, water-soluble resins, water-dispersible resins, and surfactants. Alternatively, the surface of the particles of the pigment may be oxidized or sulfonated, for example with ozone, hypochlorous acid, or fuming sulfuric acid, to render the pigment self-dispersible.

When a pigment is dispersed with a dispersing resin in the ink according to this embodiment, the ratio between the pigment and the dispersing resin is preferably from 10:1 to 1:10, more preferably from 4:1 to 1:3. Preferably, the particles of the dispersed pigment have a maximum diameter of less than 500 nm and a volume-average diameter of 300 nm or less when measured by dynamic light scattering. More preferably, the volume-average diameter is 200 nm or less.

Examples of dyes that can be used in the water-based ink composition include water-soluble dyes, such as acidic dyes, direct dyes, reactive dyes, and basic dyes, and water-dispersible dyes, such as disperse dyes, solvent dyes, and sublimation dyes.

The dyes listed above are merely examples of suitable colorants and do not limit any aspect of the present disclosure. One or a mixture of two or more such dyes may be used, with or without pigment(s).

The colorant content can be adjusted to suit the purpose of use of the ink composition. Preferably, the colorant content is 0.10% by mass or more and 20.0% by mass or less, more preferably 0.20% by mass or more and 15.0% by mass or less, even more preferably 1.0% by mass or more and 10.0% by mass or less.

When the colorant is a pigment, the volume-average diameter of the pigment particles is preferably 10.0 nm or more and 200.0 nm or less, more preferably 30.0 nm or more and 200.0 nm or less, even more preferably 50.0 nm or more and 150.0 nm or less, in particular 70.0 nm or more and 120.0 nm or less.

### Surfactant

The water-based ink composition may contain a surfactant. A function of the surfactant is to improve the wettability of the water-based ink composition on the recording medium or a substrate by reducing the surface tension of the ink composition. Acetylene glycol surfactants, silicone surfactants, and fluorosurfactants are particularly preferred.

Any kind of acetylene glycol surfactant can be used, but examples include Surfynol 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (all are trade names; Air Products and Chemicals), OLFINE B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (all are trade names; Nissin Chemical Industry), and ACETYLENOL E00, EOOP, E40, and E100 (all are trade names; Kawaken Fine Chemicals).

Any kind of silicone surfactant can be used, but an example of a preferred class is polysiloxane compounds. Any polysiloxane compound can be used, but an example is polyether-modified organosiloxanes. Examples of commercially available polyether-modified organosiloxanes include BYK-306, BYK-307, BYK-333, BYK-341, BYK-345, BYK-346, and BYK-348 (trade names, BYK Japan) and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, Shin-Etsu Chemical).

As for fluorosurfactants, a preferred class is fluorine-modified polymers. Specific examples include BYK-3440 (trade name, BYK Japan), SURFLON S-241, S-242, and S-243 (trade names, AGC Seimi Chemical), and FTERGENT 215M (trade name, NEOS).

The water-based ink composition may contain multiple surfactants. The percentage of the surfactant(s), when contained, is preferably 0.1% by mass or more and 2.0% by mass or less, more preferably 0.2% by mass or more and 1.5% by mass or less, even more preferably 0.3% by mass or more and 1.0% by mass or less of the total mass of the water-based ink composition.

It should be noted that those compounds listed above as examples of surfactants are regarded as not being organic solvents as described above.

pH-Adjusting Agent

The water-based ink composition according to this embodiment may contain a pH-adjusting agent. Using a pH-adjusting agent helps, for example, retard or accelerate the dissolution of impurities from materials forming the channel through which the ink flows, thereby helping control the detergency of the water-based ink composition. Examples of pH-adjusting agents include urea compounds, amines, morpholines, piperazines, and aminoalcohols, such as triethanolamine. Examples of urea compounds include urea, ethylene urea, tetramethylurea, thiourea, 1,3-dimethyl-2-imidazolidinone, and betaines (e.g., trimethylglycine, triethylglycine, tripropylglycine, triisopropylglycine, N,N,N-trimethylalanine, N,N,N-triethylalanine, N,N,N-triisopropylalanine, N,N,N-trimethylmethylalanine, carnitine, and acetylcarnitine). Examples of amines include diethanolamine, triethanolamine, and triisopropanolamine.

It should be noted that those compounds listed above as examples of pH-adjusting agents are regarded as not being organic solvents as described above. For example, triethanolamine is liquid at room temperature and has a normal boiling point of approximately 208° C., but is not regarded as an organic solvent as described above.

### Fungicide and Preservative

The water-based ink composition according to this embodiment may contain a preservative.

The antifungal and antibacterial properties of a preservative improve the storage stability of the ink composition. A possible advantage of using a preservative is that it allows the water-based ink composition to serve as a maintenance fluid when the printer is stored long without being used. Examples of preferred preservatives include PROXEL CRL, PROXEL BDN, PROXEL GXL, PROXEL XL-2, PROXEL IB, and PROXEL TN.

### Others

The water-based ink composition may optionally contain additives, such as chelating agents, antirusts, antimolds, antioxidants, antireductants, drying agents, and water-soluble resins.

Examples of chelating agents include ethylenediaminetetraacetic acid (EDTA) and the nitrilotriacetate, hexametaphosphate, pyrophosphate, and metaphosphate of ethylenediamine.

### 1.1.1.6. Characteristics and Other Details of the Water-Based Ink Composition

The water-based ink composition is attached to the recording medium by ink jet technology (ink attachment step). It is therefore preferred that the viscosity of the water-based ink composition be 1.5 mPa·s or more and 15.0 mPa·s or less, more preferably 1.5 mPa·s or more and 7.0 mPa·s or less, even more preferably 1.5 mPa·s or more and 5.5 mPa·s or less at 20° C. By virtue of ejection from an ink jet head to attach the water-based ink composition to the recording medium, it is easy to form an intended image on the recording medium efficiently.

Preferably, the water-based ink composition used in the ink jet recording method according to this embodiment has a surface tension at 25.0° C. of 40.0 mN/m or less, more preferably 38.0 mN/m or less, even more preferably 35.0 mN/m or less, still more preferably 30.0 mN/m or less so that it will wet and spread over the recording medium moderately.

### 1.1.1.7. Production of the Water-Based Ink Composition

It is not critical how the water-based ink composition according to this embodiment is produced. For example, the water-based ink composition can be produced by mixing its ingredients together in any order and then optionally removing impurities, for example by filtration. A suitable method for mixing the ingredients is to add the materials one by one to a container equipped with a stirring device, such as a mechanical or magnetic stirrer, and mixing the materials together by stirring.

### 1.1.2. Ink Jet Head

In the ink attachment step of the ink jet recording method according to this embodiment, a water-based ink composition as described above is ejected from an ink jet head and attached to a recording medium.

The type of ink jet head is not critical. Several types of ink jet heads are available, such as ones that perform a recording job using piezoelectric elements and ones that perform a recording job using thermal energy, for example generated by resistor elements provided in the ink jet head as heaters. Any type of ink jet head can be used.

The ink jet head used to attach the water-based ink composition to the recording medium, moreover, may have a loop in which the water-based ink composition circulates, or may not have such a loop.

### 1.1.3. Recording Medium

In the ink jet recording method according to this embodiment, the recording medium can be of any type but preferably is a low-absorbency or non-absorbent one. A low-absorbency or non-absorbent recording medium is one that absorbs little or no ink. In quantitative terms, the recording medium used in this embodiment is preferably one that absorbs 10 mL/m² or less water from the start of contact until 30 msec^{1/2} when studied by the Bristow test. The Bristow test is the most common method for brief measurement of liquid absorption and has also been adopted by Japan Technical Association of the Pulp and Paper Industry (JAPAN TAPPI). The details of the test method are set forth in No. 51 of JAPAN TAPPI Test Method 2000, which specifies the Bristow test as a method for testing the absorption of liquid in paper and paperboards. Examples of such low-absorbency or non-absorbent recording media include ones that have no absorbent ink-receiving layer, or layer absorbent to inks, on their recording surface and ones that have a coating layer that absorbs little ink on their recording surface.

Any type of non-absorbent recording medium can be used, but examples include plastic film that has no ink-absorbing layer, a sheet of paper or any other substrate with a plastic coating thereon, and a sheet of paper or any other substrate with a plastic film attached thereto. Examples of plastic materials in this context include polyvinyl chloride, polyethylene terephthalate, polycarbonate, polystyrene, polyurethane, and polyolefins, such as polyethylene and polypropylene. Polyolefins are highly flexible but only loosely hold ink when formed into film. This embodiment gives a highly resistant image even when applied to a recording medium that has a polyolefin coating or film on its surface. This embodiment is therefore useful particularly when such a recording medium is used.

The water-based ink composition according to this embodiment is also advantageous when used with a low-absorbency recording medium. Examples of low-absorbency recording media include coated paper that has a coating layer for receiving solvent ink on their surface. Any kind of coated paper can be used, but examples include paper for commercial printing, such as art paper, low coat-weight paper, and matte-coated paper.

With the water-based ink composition according to this embodiment, an intended image can be formed speedily even on such a recording medium that absorbs no or little ink. The resulting image is superior in fixation on the recording medium and abrasion resistance. These types of recording media absorb little of the solvent component(s) of ink, and any organic solvent left on such a recording medium tends to pose problems with fastness in particular, such as the abrasion resistance of the recording and the fixation of the image on the recording. The water-based ink composition according to this embodiment, however, is advantageous in that it gives a highly resistant image even when used with such a recording medium.

The recording medium, furthermore, may be shaped like a bag or may be shaped like a sheet. The surface of the recording medium may be pretreated, for example with corona discharges or a primer. Such a surface treatment can help improve the release of the ink from the recording medium.

### 1.2. Heating Step

The ink jet recording method according to this embodiment includes a heating step, in which the recording medium is heated, after the ink attachment step. The heating step is through irradiation with infrared light.

1.2.1. Irradiation with Infrared Light

The irradiation with infrared light can be done with the use of a heating device like that described in the Ink Jet Recording Apparatus section below. The heating device can be in any form as long as it delivers infrared (IR) light to the recording side of the recording medium.

The infrared light used in the heating step heats the recording medium and/or the image formed on the recording medium, thereby helping evaporate and dry volatile components contained in the image. It should be noted that the heating step herein may be referred to as secondary heating, postdrying, etc.

Secondary heating through irradiation with infrared light helps achieve strong abrasion resistance of the image, presumably because infrared light heats the attached coating of the water-based ink composition uniformly, to the inside of the coating. Infrared heating, moreover, is thermally efficient. It softens, melts, or dissolves the resin particles to a sufficient extent, but without causing excessive thermal expansion of the recording medium (hereinafter also referred to as “damage to medium” or “thermal damage-induced deformation”).

### 1.2.2. Surface Temperature

In the heating step, the recording medium may be, preferably is, heated to a surface temperature equal to or higher than the glass transition temperature of the resin particles and lower than the melting point of the wax. This is advantageous in that the resin particles in the coating of the water-based ink composition are softened, melted, or dissolved to form a smooth film, whereas the wax is prevented from forming film.

The surface temperature of the recording medium can be measured using, for example, an infrared sensor (IR sensor). As mentioned herein, the surface temperature of a recording medium in a heating step refers to the highest surface temperature the relevant portion of the recording medium reaches during the step.

In the heating step, the duration of heating may be, preferably is, such that a portion of the recording medium has a surface temperature of 80.0° C. or above for a period of 20.0 seconds or more and 120.0 seconds or less. This helps ensure that the resin particles in the coating of the water-based ink composition become sufficiently soft, whereas the wax is prevented from forming film. Firmer fixation and stronger abrasion resistance of the image are therefore achieved more easily. More preferably, the period is 30.0 seconds or more and 80.0 seconds or less, even more preferably 40.0 seconds or more and 60.0 seconds or less. The “portion” is a portion in the middle of the width of the recording medium.

### 1.2.3. Variation of the Heating Step

The heating step may further include moving the air present around the recording medium using an air-blow mechanism. The air-blow mechanism, used to move the air present around the recording medium, may deliver ambient air or may deliver warm or hot air. Adding air blowing to secondary heating is advantageous in that it helps make the drying of the solvent component(s) of the water-based ink composition even more efficient.

### 1.3. Treatment Liquid Attachment Step

The ink jet recording method according to this embodiment may include attaching a treatment liquid containing a flocculant to the recording medium.

### 1.3.1. Treatment Liquid

The treatment liquid contains a flocculant.

### 1.3.1.1. Flocculant

The treatment liquid contains a flocculant that causes the relevant component(s) of the water-based ink composition to aggregate together. The flocculant reacts with the resin particles, any colorant (when present), etc., in the water-based ink composition to cause the colorant and resin particles to aggregate together. The degree of aggregation of the colorant and resin particles caused by the flocculant varies according to, and can be controlled by changing, the type of the flocculant, colorant, and resin particles. The flocculant causes the resin particles and any colorant contained in the water-based ink composition to aggregate by reacting with them. The aggregation helps, for example, improve the color strength of the colorant, improve the fixation of the resin particles, and/or increase the viscosity of the water-based ink composition on the recording medium.

Any kind of flocculant can be used, but examples include metal salts, acids, and cationic compounds. Examples of cationic compounds that can be used include cationic resins (cationic polymers) and cationic surfactants. Among metal salts, polyvalent metal salts are particularly preferred. Among cationic compounds, cationic resins are particularly preferred. Acids include organic acids and inorganic acids, and organic acids are preferred. It is therefore preferred that the flocculant be selected from cationic resins, organic acids, and polyvalent metal salts. With these types of flocculants, the resulting image is superb in characteristics such as quality and abrasion resistance.

Although polyvalent metal salts are preferred, other metal salts can also be used. It is particularly preferred to use at least one selected from metal salts and organic acids because flocculants in these categories are highly reactive with components of ink. Among cationic compounds, cationic resins are particularly preferred because they are highly soluble in the treatment liquid. It is also possible to use multiple flocculants.

Polyvalent metal salts are compounds formed by a metal ion having a valency of 2 or more and an anion. Examples of metal ions having a valency of 2 or more include the ions of calcium, magnesium, copper, nickel, zinc, barium, aluminum, titanium, strontium, chromium, cobalt, and iron. Of such metal ions that can be a component of polyvalent metal salts, it is particularly preferred to use at least one of the calcium and magnesium ions. The calcium and magnesium ions are potent flocculants for components of ink.

The anion in a polyvalent metal salt is an inorganic or organic ion. That is, a polyvalent metal salt in this embodiment is formed by an inorganic or organic ion and a polyvalent metal. Examples of inorganic ions in this context include the chloride, bromide, iodide, nitrate, sulfate, and hydroxide ions. Examples of organic ions include organic acid ions, such as the carboxylate ion.

Ionic polyvalent metal salts are preferred. In particular, magnesium and calcium salts give the treatment liquid higher stability. The counterion for the polyvalent metal may be an inorganic acid ion or organic acid ion.

Specific examples of polyvalent metal salts include calcium carbonates, such as heavy calcium carbonate and light calcium carbonate, calcium nitrate, calcium chloride, calcium sulfate, magnesium sulfate, calcium hydroxide, magnesium chloride, magnesium carbonate, barium sulfate, barium chloride, zinc carbonate, zinc sulfide, aluminum silicate, calcium silicate, magnesium silicate, copper nitrate, calcium propionate, calcium acetate, magnesium acetate, and aluminum acetate. One such polyvalent metal salt may be used alone, or two or more may be used in combination. Metal salts that are hydrated in their raw-material form can also be used.

Examples of metal salts other than polyvalent metal salts include salts of monovalent metals, such as sodium salts and potassium salts. Examples include sodium sulfate and potassium sulfate.

Examples of suitable organic acids include poly(meth)acrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidonecarboxylic acid, pyronecarboxylic acid, pyrrolecarboxylic acid, furancarboxylic acid, pyridinecarboxylic acid, coumarinic acid, thiophenecarboxylic acid, nicotinic acid, derivatives of these compounds, and salts of these acids and their derivatives. One organic acid may be used alone, or two or more may be used in combination. Metal salts of organic acids are included in metal salts as described above.

Examples of inorganic acids include sulfuric acid, hydrochloric acid, nitric acid, and phosphoric acid. One inorganic acid may be used alone, or two or more may be used in combination.

Examples of cationic resins (cationic polymers) include cationic urethane resins, cationic olefin resins, cationic amine resins, and cationic surfactants. Water-soluble cationic polymers are preferred.

For cationic urethane resins, commercially available ones can be used. Examples include HYDRAN CP-7010, CP-7020, CP-7030, CP-7040, CP-7050, CP-7060, and CP-7610 (trade names, Dainippon Ink and Chemicals, Inc.), SUPERFLEX 600, 610, 620, 630, 640, and 650 (trade names, DKS Co. Ltd.), and WBR-2120C and WBR-2122C urethane emulsions (trade names, Taisei Fine Chemical Co., Ltd.).

Cationic olefin resins are resins that have an olefin, such as ethylene or propylene, as their structural backbone, and suitable one(s) can be selected from known ones. Cationic olefin resins in emulsion form, in which the resin has been dispersed in water or an organic or other solvent, can also be used. Commercially available cationic olefin resins can be used, such as ARROWBASE CB-1200 and CD-1200 (trade names, Unitika Ltd.).

Cationic amine resins (cationic amine polymers) include any cationic resin or polymer that has an amino group in its structure, and suitable one(s) can be selected from known ones. Examples include polyamine resins, polyamide resins, and polyallylamine resins. Polyamine resins have an amino group in their polymer backbone, polyamide resins have an amide group in their polymer backbone, and polyallylamine resins have an allyl-derived structure in their polymer backbone.

Examples of cationic polyamine resins include Senka Corporation's UNISENCE KHE103L (hexamethylenediamine/epichlorohydrin resin; pH of a 1% aqueous solution, approximately 5.0; viscosity, 20 to 50 (mPa·s); a 50% by mass solids aqueous solution) and UNISENCE KHE104L (dimethylamine/epichlorohydrin resin; pH of a 1% aqueous solution, approximately 7.0; viscosity, 1 to 10 (mPa-s); a 20% by mass solids aqueous solution). Further specific examples of commercially available cationic polyamine resins include FL-14 (trade name, SNF), ARAFIX 100, 2515, 255, and 255LOX (trade names, Arakawa Chemical), DK-6810, 6853, and 6885 and WS-4010, 4011, 4020, 4024, 4027, and 4030 (trade names, Seiko PMC), PAPYOGEN P-105 (trade name, Senka), Sumirez Resin 650(30), 675A, 6615, and SLX-1 (trade names, Taoka Chemical), Catiomaster® PD-1, 7, 30, A, PDT-2, PE-10, PE-30, DT-EH, EPA-SK01, and TMHMDA-E (trade names, Yokkaichi Chemical), and JETFIX 36N, 38A, and 5052 (trade names, Satoda Chemical Industrial).

Examples of polyallylamine resins include polyallylamine hydrochloride, polyallylamine amidosulfate, allylamine hydrochloride-diallylamine hydrochloride copolymers, allylamine acetate-diallylamine acetate copolymers, allylamine acetate-diallylamine acetate copolymers, allylamine hydrochloride-dimethylallylamine hydrochloride copolymers, allylamine-dimethylallylamine copolymers, polydiallylamine hydrochloride, polymethyldiallylamine hydrochloride, polymethyldiallylamine amidosulfate, polymethyldiallylamine acetate, polydiallyldimethylammonium chloride, diallylamine acetate-sulfur dioxide copolymers, diallylmethylethylammonium ethyl sulfite-sulfur dioxide copolymers, methyldiallylamine hydrochloride-sulfur dioxide copolymers, diallyldimethylammonium chloride-sulfur dioxide copolymers, and diallyldimethylammonium chloride-acrylamide copolymers.

For cationic surfactants, examples include primary, secondary, and tertiary amine salt compounds, alkylamine salts, dialkylamine salts, aliphatic amine salts, benzalkonium salts, quaternary ammonium salts, quaternary alkylammonium salts, alkylpyridinium salts, sulfonium salts, phosphonium salts, onium salts, and imidazolinium salts. Specific examples include hydrochlorides, acetates, and similar salts of laurylamine, coconut amine, and rosin amine as well as lauryltrimethylammonium chloride, cetyltrimethylammonium chloride, benzyltributylammonium chloride, benzalkonium chlorides, dimethylethyllaurylammonium ethyl sulfate, dimethylethyloctylammonium ethyl sulfate, trimethyllaurylammonium hydrochloride, cetylpyridinium chloride, cetylpyridinium bromide, dihydroxyethyllaurylamine, decyldimethylbenzylammonium chloride, dodecyldimethylbenzylammonium chloride, tetradecyldimethylammonium chloride, hexadecyldimethylammonium chloride, and octadecyldimethylammonium chloride.

It is also possible to use more than one of such flocculants. Using at least one selected from polyvalent metal salts, organic acids, and cationic resins helps form an image of higher quality (high color strength in particular). These types of flocculants are more potent than others.

The total flocculant content of the treatment liquid is 0.1% by mass or more and 20% by mass or less for example, preferably 1% by mass or more and 20% by mass or less, more preferably 2% by mass or more and 15% by mass or less of the total mass of the treatment liquid. When the flocculant(s) is dissolved or dispersed in the treatment liquid, too, it is preferred that the percentage be in any of these ranges on a solids basis. A flocculant content of 1% by mass or more is enough for the flocculant(s) to flocculate the relevant component(s) of the water-based ink composition effectively. A flocculant content of 30% by mass or less leads to better dissolution or dispersion of the flocculant(s) in the treatment liquid, thereby helping improve, for example, the storage stability of the treatment liquid.

Preferably, the solubility of the flocculant in 100 g of water at 25° C. is 1 g or more, more preferably 3 g or more and 80 g or less. This ensures the flocculant dissolves well in the treatment liquid even when the treatment liquid contains a highly hydrophobic organic solvent.

### 1.3.1.2. Extra Ingredients

Besides the flocculant, the treatment liquid may contain ingredients such as organic solvents, surfactants, water, excipients, preservatives/antimolds, antirusts, chelating agents, viscosity modifiers, antioxidants, and fungicides unless its functions are impaired. Extra ingredients in the treatment liquid are not described in detail. The same applies as in the Water-Based Ink Composition section above.

### 1.3.2. Characteristics of the Treatment Liquid and Attachment to the Recording Medium

When a treatment liquid is used in the recording method according to this embodiment, it is preferred that the treatment liquid have a surface tension at 25° C. of 40 mN/m or less, more preferably 38 mN/m or less, even more preferably 35 mN/m or less, still more preferably 30 mN/m or less. This ensures the treatment liquid wets and spreads over the recording medium moderately. The surface tension can be measured by wetting a platinum plate with the treatment liquid and checking the surface tension under 25.0° C. conditions using CBVP-Z automated surface tensiometer (Kyowa Interface Science).

The attachment of the treatment liquid to the recording medium can be achieved by a direct or indirect contact technique, such as ink jet technology, coating, spraying the recording medium with the treatment liquid, dipping the recording medium in the treatment liquid, or applying the treatment liquid using a brush or similar tool. A combination of multiple techniques can also be used.

Preferably, the treatment liquid is attached to the recording medium by ink jet technology. When this is the case, it is preferred that the treatment liquid have a viscosity at 20° C. of 1.5 mPa·s or more and 15 mPa·s or less, more preferably 1.5 mPa·s or more and 7 mPa·s or less, even more preferably 1.5 mPa·s or more and 5.5 mPa·s or less. Using ink jet technology is an easy way to attach the treatment liquid to an intended region of the recording medium efficiently.

### 1.4. Operations, Effects, and Mechanisms

The ink jet recording method according to this embodiment uses a water-based ink composition that contains resin particles and wax. The volume-average diameter A of the resin particles is 90.0 nm or more, and the ratio between the volume-average diameter A and the volume-average diameter B of the particles of the wax (B/A) is 0.7 or more. Irradiation with infrared light is performed in a heating step. By virtue of these, the image formed is firmly fixed and is highly resistant to abrasion. The water-based ink composition, moreover, is highly stable when stored.

In order for the resulting recording to be resistant to abrasion, the resin particles, used in the water-based ink composition as a fixing resin, need to dissolve and become smooth in response to secondary heating. The particles of the wax, on the other hand, do not form film. They are left on the surface of the image in particulate form or as an uneven coating, lubricating the surface. As a result, the inventor believes, the recorded image is of strong abrasion resistance.

A water-based ink composition containing resin particles with too small a volume-average diameter, however, can clog the nozzles of an ink jet head used therewith because of the fusing together of the resin particles. To address this, the water-based ink composition used in the recording method according to this embodiment is made with relatively large resin particles, ones having a volume-average diameter of 90.0 nm or more. This helps reduce clogging.

The resin particles provide strong abrasion resistance by dissolving well and forming smooth film in secondary heating. Because of their relatively large volume-average diameter, however, the resin particles do not soften or melt to a sufficient extent except with infrared secondary heating. Insufficient softening or melting of the resin particles can result in insufficient abrasion resistance of the image.

In the ink jet recording method according to this embodiment, secondary heating is through irradiation with infrared light. This gives the image sufficiently high abrasion resistance. Infrared light, moreover, is thermally efficient. It heats the coating of the water-based ink composition relatively uniformly, to the inside of the coating, and dissolves the resin particles to a sufficient extent, but without causing excessive thermal damage-induced deformation of the recording medium.

Except by irradiation with infrared light, the heating step would fail to heat the coating uniformly including the inside. The coating would be heated to a sufficient extent only when, for example, the heating temperature is so high. Excessive heating would cause part of the coating to be too hot, resulting in problems such as the formation of film by molten wax.

The water-based ink composition used in the recording method according to this embodiment, furthermore, is made with a wax whose particles have a relatively large volume-average diameter. This helps achieve even higher abrasion resistance of the image. Larger volume-average diameters of the particles of the wax are more effective in lubricating the surface of the image. It should be noted that a wax that melts during secondary heating would fail to lubricate the surface of the image. The ink jet recording method according to this embodiment uses a wax whose particles have a relatively large diameter, and this advantageously prevents the wax from forming film in secondary heating.

The infrared light, furthermore, may be emitted from above the coating of the water-based ink composition. In this setting, the energy of the radiation is not blocked by the recording medium. The coating is heated efficiently, including its inside. Waxes generally have a small relative density, and the wax in the coating of the water-based ink composition also tends to concentrate on the upper side of the coating. The wax, therefore, is probably exposed to more heat from the infrared light than the other components, but at the same time is highly transparent to infrared light (has high infrared transmittance). Hence the infrared light heats the coating uniformly, not only the upper part but also the inside, and the energy of the infrared light is delivered efficiently to the resin particles, which concentrate on the recording medium side of the coating. As a result, a sufficient amount of heat reaches the inside of the coating, without being blocked by the large-diameter particles of the wax present in the upper part of the coating.

Preferably, the volume-average diameter of the particles of the wax is equal to or smaller than a particular limit. Too large a volume-average diameter increases the risk that the wax will separate out on the surface of the water-based ink composition during storage. Resin particles having a low glass transition temperature are better because they easily soften and melt when heated in secondary heating. As for the wax, ones having a high melting point are better because they do not easily form film when heated in secondary heating.

### 2. INK JET RECORDING APPARATUS

An ink jet recording apparatus according to this embodiment is configured to perform the ink jet recording method described above. The following describes an example of an ink jet recording apparatus suitable for use with water-based ink compositions according to an embodiment with reference to drawings. In the drawings referenced in the following description, the scale and relative dimensions of elements may vary so that each element is recognizable.

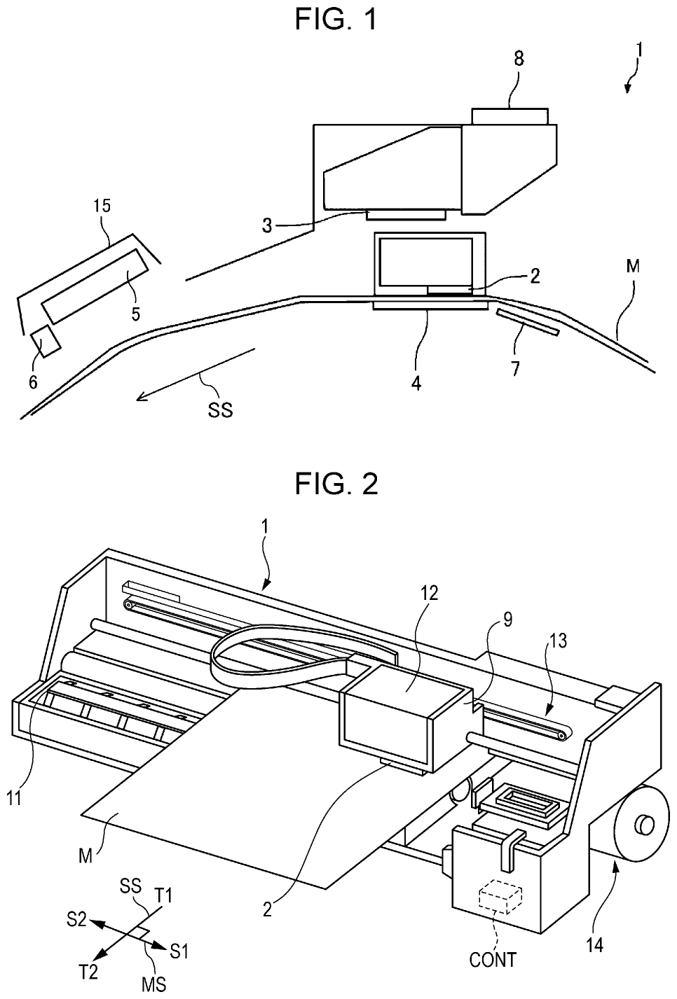

FIG. 1 is an outline cross-sectional diagram schematically illustrating an ink jet recording apparatus 1 as an example of a recording apparatus. FIG. 2 is a perspective view of the carriage and related components of the ink jet recording apparatus 1 in FIG. 1, illustrating an exemplary configuration. As illustrated in FIGS. 1 and 2, the ink jet recording apparatus 1 includes an ink jet head 2, a heater 3, a platen heater 4, an infrared heater 5, a fan 6, a preheater 7, an aeration fan 8, a carriage 9, a platen 11, a carriage-moving mechanism 13, a transporter 14, and a control section CONT. By the control section CONT, illustrated in FIG. 2, the overall operation of the ink jet recording apparatus 1 is controlled.

The ink jet head 2 is configured to perform recording on a recording medium M by ejecting a treatment liquid and a water-based ink composition through its nozzles and attaching them to the recording medium M. In the illustrated example, the ink jet head 2 is a serial ink jet head: it attaches the treatment liquid and water-based ink composition to the recording medium M by scanning relative to the recording medium M in a main scanning direction multiple times. The ink jet head 2 is on the carriage 9, illustrated in FIG. 2. As the carriage-moving mechanism 13 forces the carriage 9 to move in the direction of medium width or along the width of the recording medium M, the ink jet head 2 scans relative to the recording medium M in the main scanning direction multiple times. The direction of medium width is the main scanning direction, i.e., the direction in which the ink jet head 2 scans. A scan in the main scanning direction is also referred to as a main scan.

The main scanning direction, moreover, is the direction in which the carriage 9 moves with the ink jet head 2 thereon. In FIG. 1, the main scanning direction is the direction that crosses a sub-scanning direction, indicated by arrow SS, which is the direction of transport of the recording medium M. In FIG. 2, the direction along the width of the recording medium M, i.e., direction S1-S2, is the main scanning direction MS, and the direction of T1→T2 is the sub-scanning direction SS. During a scan, the ink jet head 2 scans in the main scanning direction, i.e., in either of the directions of arrows S1 and S2. A main scan, made by the ink jet head 2, and a sub-scan, which is the transport of the recording medium M, are repeated to perform recording on the recording medium M. That is, the treatment liquid and water-based ink composition attachment steps are carried out through multiple main scans as movements of the ink jet head 2 in the main scanning direction and multiple sub-scans as movements of the recording medium M in the sub-scanning direction, which crosses the main scanning direction.

A cartridge assembly 12, which supplies the treatment liquid and water-based ink composition to the ink jet head 2, includes multiple independent cartridges. The cartridge assembly 12 has been detachably attached to the carriage 9 carrying the ink jet head 2 thereon. Each cartridge contains a different kind of water-based ink composition or treatment liquid, and the water-based ink composition and treatment liquid are supplied from the cartridge assembly 12 to the nozzles. Although the cartridge assembly 12 in the illustrated example is on the carriage 9, this is not the only possible configuration. The cartridge assembly 12 may be somewhere other than the carriage 9, and the ink and treatment liquid may be supplied to the nozzles through feed tubes not illustrated.

The ejection from the ink jet head 2 can be in any known mode. The illustrated example employs a mode in which vibrations of piezoelectric elements are used to eject droplets, i.e., an ejection mode in which mechanical deformation of electrostrictive elements is used to form ink droplets.

The ink jet recording apparatus 1 may include a drying mechanism that performs a drying step for drying the recording medium M while the water-based ink composition is ejected from the ink jet head 2 and attached to the recording medium (primary heating). Heat or air-blow drying can be used. The drying mechanism can be, for example, a conduction, air-blow, or radiation drying mechanism. A conduction drying mechanism comes into contact with the recording medium M and conducts heat to the recording medium M. An example is the platen heater 4 illustrated in the drawings. An air-blow drying mechanism delivers ambient or warm air to the recording medium M to cause the water-based ink composition, for example, to dry. An example is the aeration fan 8. A radiation drying mechanism irradiates the recording medium M with heat radiation to heat the recording medium. An example is using an infrared heater as the heater 3 and emitting infrared light from it. One such drying mechanism may be used alone, or a combination may be used.

When a drying step (primary heating) is performed to dry the recording medium M, the heater 3 and the aeration fan 8, for example, can be used. By using the heater 3, the recording medium M can be heated from the ink jet head 2 side by radiation heating through irradiation with infrared light. This often causes the ink jet head 2, too, to be heated, but helps elevate the temperature of the recording medium M with less influence of its thickness than with heating from the back of the recording medium M, for example using the platen heater 4. The ink jet recording apparatus 1 may include a fan that dries the treatment liquid and water-based ink composition on the recording medium M by blowing warm air or air at the ambient temperature against the recording medium M (e.g., the aeration fan 8).

The platen heater 4 is positioned opposite the ink jet head 2 and is configured to heat the recording medium M via the platen 11 interposed therebetween to accelerate the drying of the water-based ink composition ejected from the ink jet head 2 and attached to the recording medium M. The platen heater 4 is configured to heat the recording medium M by conduction heating, and the use of it is optional in this ink jet recording method. When used, the platen heater 4 is preferably controlled to make the surface temperature of the recording medium M 45.0° C. or less. Although not illustrated, a line ink jet recording apparatus would have an underheater as an equivalent to the platen heater 4. When a drying step using a drying mechanism is not performed, no drying mechanism is needed.

In the ink attachment step, the recording medium M is heated preferably to a surface temperature of 45.0° C. or less, more preferably 40.0° C. or less, even more preferably 38.0° C. or less, in particular 35.0° C. or less for the upper limit. As for the lower limit, the recording medium M is heated preferably to a surface temperature of 25.0° C. or more, more preferably 28.0° C. or more, even more preferably 30.0° C. or more, in particular 32.0° C. or more. This helps limit the drying and chemical alteration of the water-based ink composition while in the ink jet head 2, thereby helping prevent the deposition of the water-based ink composition and resin(s) therein on the inner walls of the ink jet head 2. Heating the recording medium M to such a surface temperature also encourages early fixation of the treatment liquid and water-based ink composition on the recording medium M, thereby helping reduce the transfer of the ink to the back of the recording medium M. As a result, image quality is improved.

This temperature is the highest surface temperature the portion of the recording medium facing the ink jet head reaches during the ink attachment step. When the ink attachment step includes a drying step performed using a drying mechanism, this temperature is also the temperature for this drying step.

The ink jet recording apparatus 1 according to this embodiment includes an infrared heater 5 as a heating device with which a heating step can be performed after the ink attachment step in which the recording medium M is heated to dry and fix the ink (secondary heating).

The infrared heater 5, used in the postheating step, is a heater that dries and solidifies the water-based ink composition attached to the recording medium M, i.e., a heater for secondary heating or secondary drying. The infrared heater 5 can be used in the postheating step. With the infrared heater 5 heating the recording medium M with a recorded image thereon, the water, for example, in the water-based ink composition evaporates away more quickly than without it. The resin(s) contained in the water-based ink composition forms ink film, and the ink film becomes firmly fixed on or adheres strongly to the recording medium M. With this good film formation capability, the ink jet recording apparatus 1 produces a good and high-quality image in a short time. A hood 15 keeps the recording medium M hot by covering the infrared heater 5 and related components.

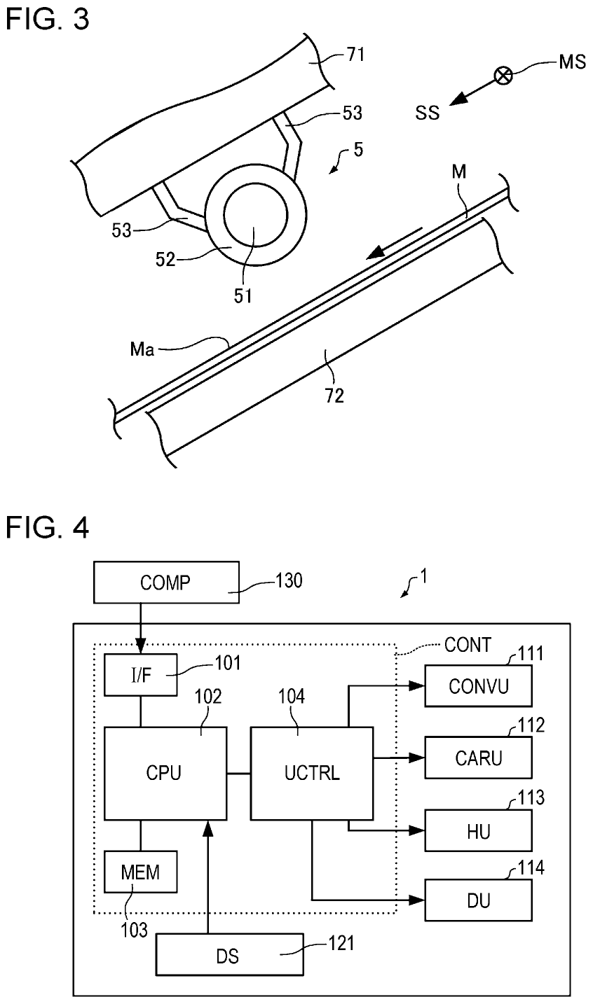

FIG. 3 is a schematic view of an example of an infrared heater 5, illustrating a cross-section viewed in a direction along the main scanning direction MS. As illustrated in FIG. 3, the infrared heater 5 has a tube 52 placed along the main scanning direction MS, a heating element 51 inserted in the tube 52, and a support 53 that holds the tube 52. The tube 52 is preferably made of metal, in particular iron. Preferably, the total length of the tube 52 along the main scanning direction MS is longer than the width, along the main scanning direction MS, of the recording medium M with a sufficient margin. This ensures the entire image is irradiated with infrared light while the recording medium M passes under the tube 52.

The heating element 51 generates heat when electricity is applied to it. An example is heating wire, such as nichrome wire. The heat generated by the heating element 51 heats the tube 52, causing infrared emissions. The water and other volatile components in the ink evaporate, and the image dries. The support 53 is configured to hold the tube 52 from above. In the illustrated example, the support 53 holds the tube 52 on an enclosure 71. The recording surface Ma of the recording medium M is irradiated with infrared light, and there is a guide 72 under the other side of the recording medium M to support the recording medium M.

Adding such an infrared heater 5 to the aforementioned heating with the heater 3 helps ensure that all water, for example, in the image evaporates away, even when the heating with the heater 3 leaves some.

The tube 52 is heated to a temperature of 300° C. or more and 700° C. or less for example, preferably so that the surface temperature of the recording medium M will be 80.0° C. or more and 120.0° C. or less for example. Parameters such as the power of the infrared heater 5 and the rate of transport of the recording medium M may be controlled so that the recording medium M will have a surface temperature of 80.0° C. or above for a period of 20.0 seconds or more and 120.0 seconds or less as mentioned above.

To detect the surface temperature of the recording medium M, an infrared sensor, for example, can be used.

Preferably, the infrared heater 5 heats the recording medium M to a surface temperature of 120.0° C. or less, more preferably 100.0° C. or less, even more preferably 90.0° C. or less for the upper limit. As for the lower limit, the recording medium M is heated preferably to a surface temperature of 60.0° C. or more, more preferably 70.0° C. or more, even more preferably 80.0° C. or more. A surface temperature in these ranges ensures a high-quality image will be obtained in a short time. A line ink jet recording apparatus would have an afterheater as an equivalent to the infrared heater 5. The afterheater can be, for example, a carbon heater.

The ink jet recording apparatus 1 may have a fan 6. The fan 6 is an air-blow mechanism and is configured to move the air present around the recording medium M. Using the fan 6 helps cool, additionally dry, or additional heat the water-based ink composition attached to the recording medium M after or during the heating step (irradiation with infrared light). The gas delivered from the fan 6, therefore, may be a gas at room temperature or may be warm air. The air can be blown, for example, parallel with the surface of the recording medium M or against the surface of the recording medium M. When the air is blown parallel with the surface of the recording medium M, the direction of the wind can be opposite or in the same direction as the transport of the recording medium M.

The ink jet recording apparatus 1 may include a preheater 7 that heats the recording medium M preliminarily, before the attachment of the water-based ink composition to the recording medium M. The ink jet recording apparatus 1, moreover, may include an aeration fan 8 so that the treatment liquid and water-based ink composition attached to the recording medium M will dry more efficiently. A line ink jet recording apparatus, too, could have a preheater 7.

Under the carriage 9 are a platen 11 that supports the recording medium M, a carriage-moving mechanism 13 that moves the carriage 9 relative to the recording medium M, and a transporter 14 that is a roller that transports the recording medium M in the sub-scanning direction. The operation of the carriage-moving mechanism 13 and the transporter 14 is controlled by the control section CONT.

FIG. 4 is a functional block diagram for the ink jet recording apparatus 1. The control section CONT is a control unit for controlling the ink jet recording apparatus 1. The interface 101 (I/F) is for exchanging data between a computer 130 (COMP) and the ink jet recording apparatus 1. The CPU 102 is a processing unit for overall control of the ink jet recording apparatus 1. The memory 103 (MEM) is for, for example, storing programs and providing workspace for the CPU 102. The CPU 102 controls each unit via a unit control circuit 104 (UCTRL). A set of detectors 121 (DS) monitor the internal status of the ink jet recording apparatus 1. Based on detected events, the control section CONT controls each unit.

The transport unit 111 (CONVU) is a unit that controls sub-scans (transport) in an ink jet recording job, specifically the direction and rate of transport of the recording medium M. To be more specific, the transport unit 111 controls the direction and rate and of transport of the recording medium M by controlling the direction and rate of rotation of a motor-driven transport roller.

The carriage unit 112 (CARU) is a unit that controls main scans (passes) in an ink jet recording job, or specifically a unit that moves the ink jet head 2 back and forth in the main scanning direction. The carriage unit 112 includes a carriage 9 for the ink jet head 2 and a carriage-moving mechanism 13 for moving the carriage 9 back and forth.

The head unit 113 (HU) is a unit that controls the volumes ejected from the nozzles of the ink jet head 2 of the treatment liquid and water-based ink composition. For example, when the nozzles of the ink jet head 2 are ones driven by piezoelectric elements, the head unit 113 controls the operation of the piezoelectric element in each nozzle. By the head unit 113, parameters such as the timing of attachment and size of each droplet of the treatment liquid and water-based ink composition are controlled. The carriage unit 112 and the head unit 113, moreover, together control the volumes of the treatment liquid and water-based ink composition attached per scan.

The drying unit 114 (DU) controls the temperature of heaters, such as the heater 3, preheater 7, platen heater 4, and infrared heater 5.

This ink jet recording apparatus 1 alternates the operation of moving the carriage 9, with the ink jet head 2 thereon, in the main scanning direction and the transport operation (sub-scans). During each pass, the control section CONT controls the carriage unit 112 to move the ink jet head 2 in the main scanning direction, and also controls the head unit 113 to eject droplets of the treatment liquid and water-based ink composition from predetermined nozzle orifices of the ink jet head 2 and attach the ejected droplets to the recording medium M. The control section CONT also controls the transport unit 111 to transport the recording medium M in the direction of transport by a predetermined distance (feed) during the transport operation.

As the ink jet recording apparatus 1 repeats a main scan (pass) and a sub-scan (transport operation), a recording region is transported little by little with attached multiple droplets thereon. Then the infrared heater 5 is used to dry the droplets attached to the recording medium M, finishing an image. The finished recording may then be rolled by a rolling mechanism or transported on a flatbed mechanism.

The foregoing is a description of a serial recording apparatus, which has a serial ink jet head and performs serial recording. The ink jet head 2, however, may alternatively be a line head. An ink jet head for a line recording apparatus has nozzles arranged over a length equal to or longer than the width of the recording medium M used therewith and attaches water-based ink composition(s) to the recording medium M in one pass.

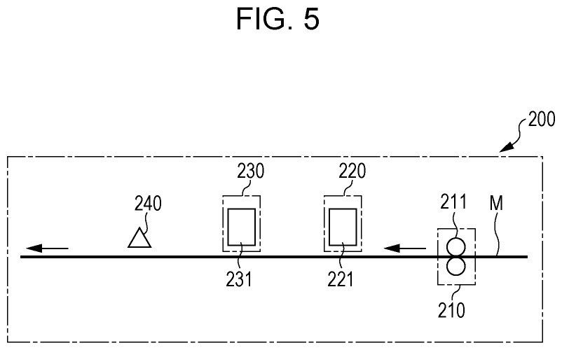

FIG. 5 is an outline cross-sectional diagram schematically illustrating part of a line recording apparatus, which has a line head (line ink jet head) and performs line recording. The part 200 of the recording apparatus includes a treatment liquid applicator 220, which includes an ink jet head 221 for a treatment liquid; an ink composition applicator 230, which includes an ink jet head 231 for an ink composition; a recording medium transporter 210, which includes transport rollers 211 that transport a recording medium M; and at least one postheating device 240, with which the recording medium M is subjected to a heating step (secondary heating). In this embodiment, the postheating device 240 is an infrared heater and/or a carbon heater so that the image can be irradiated with infrared light. The ink jet heads 231 and 221 are line ink jet heads, which have lines of nozzles extending in the direction of width of the recording medium M, or in the front-back direction in the drawing.

A line recording apparatus transports the recording medium M in the direction of transport, indicated by arrows in FIG. 5, to change the relative positions of the ink jet heads 231 and 221 and the recording medium M, and at the same time ejects a treatment liquid and an ink composition from the ink jet heads 231 and 221 and attaches them to the recording medium M. This is referred to as a scan, and a scan is also referred to as a main scan or a pass. Line recording is a one-pass recording method, in which a recording job is performed by attaching a treatment liquid and an ink composition to a transported recording medium M in one pass using ink jet heads 231 and 221.

A line recording apparatus includes a line ink jet head and performs line recording, but otherwise it can be the same as the serial ink jet recording apparatus 1 described above. A line recording apparatus may include a drying device with which a drying step is performed. For example, a line recording apparatus may have drying devices like the aeration fan 8 and heater 3, which are above the ink jet head 2 in FIG. 1, above the ink jet heads 231 and 221 in FIG. 5 and may also have an underheater or any other drying device corresponding to the platen heater 4, which is under the ink jet head 2 in FIG. 1, under the ink jet heads 231 and 221 in FIG. 5.

### 3. EXAMPLES AND COMPARATIVE EXAMPLES

The following describes an aspect of the present disclosure in detail by providing examples and comparative examples, but no aspect of the disclosure is limited to these Examples. Various modifications can be made without departing from the gist of the particular aspect of the disclosure. Amounts of materials in the unit of % or parts are by mass unless stated otherwise.

### 3.1. Preparation of Water-Based Ink Compositions and Treatment Liquids

Inks A to L (water-based ink compositions) and treatment liquids A to C were prepared according to the formulae presented in Tables 1 and 2. The preparation of each ink or treatment liquid was as follows: The ingredients, specified in Table 1 or 2, were put into a container, mixed by stirring for 2 hours using a magnetic stirrer, and the resulting mixture was filtered through a 5-μm membrane filter to remove impurities, such as dust and coarse particles. The amounts of ingredients in Tables 1 and 2 are all in % by mass, and the purified water was added to make the total mass of the composition 100%.

The water-based ink compositions were made with a colorant (liquid dispersion of a magenta pigment) that was prepared beforehand as follows. Forty parts by mass of a styrene-acrylic acid copolymer (copolymer of methacrylic acid, butyl acrylate, styrene, and hydroxyethyl acrylate in a ratio by mass of 25/50/15/10; weight-average molecular weight, 7000; acid value, 150 mg KOH/g) was added to a mixture of 7 parts by mass of potassium hydroxide, 23 parts by mass of water, and 30 parts by mass of triethylene glycol mono-n-butyl ether. The resulting mixture was heated with stirring at 80° C. to give an aqueous solution of resin. Ten parts by mass of this aqueous solution of resin was mixed with 20 parts by mass of a magenta pigment (C.I. Pigment Red 122), 10 parts by mass of diethylene glycol, and 60 parts by mass of deionized water. The pigment was dispersed using a zirconia bead mill, giving a liquid dispersion of the pigment.

In the preparation of the water-based ink compositions, waxes (wax emulsions) were also used. The waxes were prepared beforehand as follows.

To 30 parts by mass of a polyethylene wax having a melting point of 130° C. were added 64 parts by mass of deionized water, 5 parts by mass of EMULGEN 430 (trade name; Kao Corporation; a polyoxyethylene oleyl ether emulsifier), and 1 part by mass of a 48% aqueous solution of potassium hydroxide. After the container was purged with nitrogen and tightly sealed, the mixture was stirred at a high speed for 1 hour at 160° C., then cooled to 90° C., and passed through a high-pressure homogenizer to give a water-based wax emulsion (wax 1). The volume-average diameter of particles was 200 nm.

Based on this procedure, waxes 2 to 5, having different volume-average diameters of particles, were produced using waxes having different melting points and with the pressure of the high-pressure homogenizer and the cooling rate modified. Waxes 1 to 4 were nonionically dispersed waxes. In the preparation of wax 5, the emulsifier was changed to an anionic one (Newcol 2320-SN; trade name; Nippon Nyukazai Co., Ltd.). Wax 5 was therefore an anionically dispersed wax.

Liquid dispersions of resin particles were also used in the water-based ink compositions. They were prepared beforehand as follows.

Seventy-five parts by mass of styrene, 0.8 parts by mass of acrylic acid, 14.2 parts by mass of methyl methacrylate, and 10 parts by mass of cyclohexyl methacrylate were copolymerized by emulsion polymerization to give a resin emulsion. The emulsion polymerization was performed using Newcol NT-30 surfactant (Nippon Nyukazai Co., Ltd.), and its amount was 2 parts by mass in 100 parts by mass of the monomers. Based on this procedure, a liquid dispersion of resin particles (resin 1) was prepared using different monomers in different proportions. Resin 1 had a glass transition temperature of 80° C., and the volume-average diameter of particles therein was 190 nm.

Based on the procedure for producing resin 1, more liquid dispersions of resin particles (resins 2 to 4) were prepared. The monomers and their proportions were further changed to modify the glass transition point (glass transition temperature) of the resins, and the amount of the surfactant for emulsion polymerization was changed to control the volume-average diameter of particles.

In Table 1, the values in the Liquid dispersion of pigment, Resin, and Wax rows are the solids content in % by mass calculated from the concentration of solids in each substance.

TABLE 1

| | | Ink A | Ink C | Ink D | Ink E | Ink F | Ink G | Ink H | Ink I | Ink J | Ink K | Ink L | Ink B |
|---|---|---|---|---|---|---|---|---|---|---|---|---|---|
| Organic | Propylene glycol | 10.0 | 10.0 | 10.0 | 10.0 | 10.0 | 10.0 | 10.0 | 15.0 | 10.0 | 10.0 | 10.0 | 10.0 |
| solvents | (boiling point, | | | | | | | | | | | | |
| | 189° C.) | | | | | | | | | | | | |
| | 2-Pyrrolidone | 15.0 | 15.0 | 15.0 | 15.0 | 15.0 | 15.0 | 15.0 | 15.0 | 15.0 | 15.0 | 15.0 | 15.0 |
| | (boiling point, | | | | | | | | | | | | |
| | 245° C.) | | | | | | | | | | | | |
| | 1,2-Hexanediol | 2.0 | 2.0 | 2.0 | 2.0 | 2.0 | 2.0 | 2.0 | 2.0 | 2.0 | 2.0 | 2.0 | 2.0 |
| | (boiling point, | | | | | | | | | | | | |
| | 223° C.) | | | | | | | | | | | | |
| Liquid | Liquid dispersion | 4.0 | 4.0 | 4.0 | 4.0 | 4.0 | 4.0 | 4.0 | 4.0 | 4.0 | 4.0 | 4.0 | 4.0 |
| dispersion | of magenta | | | | | | | | | | | | |
| of pigment | pigment (pigment | | | | | | | | | | | | |
| | solids content) | | | | | | | | | | | | |
| Resin | Resin 1 (190 nm) | 6.0 | 6.0 | — | — | — | 6.0 | 6.0 | 6.0 | 6.0 | 4.0 | — | 6.0 |
| | Resin 2 (100 nm) | — | — | 6.0 | 6.0 | — | — | — | — | — | — | — | — |
| | Resin 3 (190 nm) | — | — | — | — | 6.0 | — | — | — | — | — | — | — |
| | Resin 4 (50 nm) | — | — | — | — | — | — | — | — | — | — | 6.0 | — |
| Wax | Wax 1 (200 nm) | 0.5 | — | 0.5 | — | 0.5 | — | 1.0 | 0.5 | — | 0.5 | 0.5 | — |
| | Wax 2 (80 nm) | — | — | — | 0.5 | — | — | — | — | — | — | — | 0.5 |
| | Wax 3 (150 nm) | — | 0.5 | — | — | — | — | — | — | — | — | — | — |
| | Wax 4 (200 nm) | — | — | — | — | — | 0.5 | — | — | — | — | — | — |
| | Wax 5 (200 nm) | — | — | — | — | — | — | — | — | 0.5 | — | — | — |
| Defoamer | Surfynol DF110D | 0.1 | 0.1 | 0.1 | 0.1 | 0.1 | 0.1 | 0.1 | 0.1 | 0.1 | 0.1 | 0.1 | 0.1 |
| Surfactant | BYK348 | 1.0 | 1.0 | 1.0 | 1.0 | 1.0 | 1.0 | 1.0 | 1.0 | 1.0 | 1.0 | 1.0 | 1.0 |
| Purified water | | Balance | Balance | Balance | Balance | Balance | Balance | Balance | Balance | Balance | Balance | Balance | Balance |
| Total | | 100 | 100 | 100 | 100 | 100 | 100 | 100 | 100 | 100 | 100 | 100 | 100 |
| Particle | Wax D50/ | 1.1 | 0.8 | 2 | 0.8 | 1.1 | 1.1 | 1.1 | 1.1 | 1.1 | 1.1 | 1.1 | 0.4 |
| diameter | Resin D50 | | | | | | | | | | | | |
| ratio | | | | | | | | | | | | | |

TABLE 2

| | | Treatment | Treatment | Treatment |
|---|---|---|---|---|
| | | liquid A | liquid B | liquid C |
| Organic | Propylene glycol | 10.0 | 10.0 | 10.0 |
| solvents | 2-Pyrrolidone | 15.0 | 15.0 | 15.0 |
| | 1,2-Hexanediol | 2.0 | 2.0 | 2.0 |
| Flocculant | Calcium acetate | 5.0 | — | — |
| | monohydrate | | | |
| | Malonic acid | — | 5.0 | — |
| | Catiomaster PD-7 | — | — | 5.0 |
| | (solids content) | | | |
| Defoamer | DF110D | 0.1 | 0.1 | 0.1 |
| Surfactant | BYK348 | 1.0 | 1.0 | 1.0 |

| | | | |
|---|---|---|---|
| Purified water | Balance | Balance | Balance |
| Total | 100 | 100 | 100 |

The characteristics and other details of the substances in Tables 1 and 2 were as follows.
Resin 1: Glass transition temperature, 80° C.; volume-average diameter of particles (D50), 190 nm
Resin 2: Glass transition temperature, 80° C.; volume-average diameter of particles (D50), 100 nm
Resin 3: Glass transition temperature, 60° C.; volume-average diameter of particles (D50), 190 nm
Resin 4: Glass transition temperature, 80° C.; volume-average diameter of particles (D50), 50 nm
Wax 1: Melting point, 130° C.; volume-average diameter of particles (D50), 200 nm; density, 0.98 (g/cm³)
Wax 2: Melting point, 130° C.; volume-average diameter of particles (D50), 80 nm; density, 0.98 (g/cm³)
Wax 3: Melting point, 130° C.; volume-average diameter of particles (D50), 150 nm; density, 0.98 (g/cm³)
Wax 4: Melting point, 105° C.; volume-average diameter of particles (D50), 200 nm; density, 0.93 (g/cm³)
Wax 5: Melting point, 130° C.; volume-average diameter of particles (D50), 200 nm; density, 0.98 (g/cm³)
Surfynol DF110D: Trade name, Air Products, an acetylene glycol surfactant (defoamer)
BYK-348: Trade name, BYK Japan KK, a silicone surfactant
Catiomaster PD-7: Trade name, Yokkaichi Chemical, Co., Ltd., a polyamine resin (epichlorohydrin-amine derivative)

In the above list of materials, the volume-average diameters of particles were determined by diluting the emulsions in 100 volumes of water and analyzing the dilutions for the diameter of particles (volume average) therein using Nanotec Wave II-EX150 DLS (dynamic light scattering) particle size analyzer (MicrotracBEL Corporation). The glass transition temperatures (Tg) of resin particles were measured by differential scanning calorimetry (DSC) (model DSC 6220, Seiko Instruments Inc.). The melting points of the waxes were also measured using a differential scanning calorimeter (model DSC 6220, Seiko Instruments Inc.). A sample of each wax was heated to 150° C., cooled to −30° C., and then heated to 150° C. once again (all at a rate of 20° C. per minute), and the melting point was calculated from the peak observed during the second period of heating.

### 3.2. Testing

### 3.2.1. Recording Test

Recordings were produced as follows. The printer was a modified version of SC-S40650 (model number, Seiko Epson Corporation) fitted with a far-infrared heater and a fan for secondary heating as in FIGS. 1 and 3 (hereinafter also referred to as “modified SC-S40650”). The recording resolution and the number of passes were 720×1440 dpi and eight, respectively. In the tables, the print temperature is the surface temperature to which the recording medium was heated in the attachment step and was achieved by programming a platen heater. In the printing of a solid image, the amounts of water-based ink composition and treatment liquid attached were 12 mg/inch² and 1.2 mg/inch², respectively. For the temperature for secondary heating, the surface temperature of the recording medium was controlled as in the tables by programming the infrared heater accordingly. The duration of secondary heating was changed as in the tables by customizing the length of the heater for secondary heating along the direction of feeding of the recording medium. This duration represents the period of time for which a point on the surface of the recording medium was at 80° C. or above in the secondary heating step. The treatment liquid was ejected using an ink jet head located upstream in the direction of feeding of the recording medium, and the water-based ink composition was ejected using a downstream one. The “point” on the surface of the recording medium was a point in the middle of the width of the recording medium.

Tables 3 to 5 include data on the type of recording medium used. The following recording media were used.
M1: ORAJET 3169G-010 (trade name, ORAFOL Japan Inc., a polyvinyl chloride film)
M2: H5469-0295 (trade name, Heytex, a tarpaulin)

In Tables 3 to 5, the meanings of “IR,” “IR+Air,” “Hot air,” and “Conduction” are as follows.
IR: The far-infrared heater was used.
IR+Air: The far-infrared heater and ambient air from the fan were used. The velocity of the air was 3 m/s.
Hot air: The recording medium was exposed to hot air from the fan. The temperature of the hot air was as in the table. The velocity of the air was 3 m/s.
Conduction: The recording medium was heated using a contact electric heater placed therebeneath. A guide was interposed between the recording medium and the heater to touch the back of the recording medium.

### 3.2.2. Abrasion Resistance

Using the modified SC-S40650, a solid image was printed on the recording medium with the water-based ink composition assigned to the Example or Comparative Example. In some Examples, a set of a water-based ink composition and a treatment liquid was used. The printed article was left at room temperature for 30 minutes. The portion with the printed solid image thereon was cut into a rectangle measuring 30×150 mm, and this cut specimen was rubbed 50 times with a piece of plain-woven fabric using a color fastness rubbing tester (load, 500 g). The rubbed specimen was visually inspected for ink detachment, and the degree of detachment was graded according to the criteria below. The results are presented in Tables 3 to 5.

AA: No ink detached.

A: No ink detached, but some transferred to the piece of fabric.

B: Ink detached in less than 10% of the area tested.

C: Ink detached in 10% or more and less than 50% of the area tested.

D: Ink detached in 50% or more of the area tested.

3.2.3. Recovery from Clogging

The modified SC-S40650 was loaded with the water-based ink composition assigned to the Example or Comparative Example. In Examples 14 to 17, the assigned set of a water-based ink composition and a treatment liquid was used. The nozzle face of the ink-composition ink jet head was patted with a wet Bemcot wiper to clog most of the nozzles intentionally. In this state, a recording job was simulated for 3 hours straight under 35° C. and 15% RH conditions with the recording parameters assigned to the Example or Comparative Example. That is, a recording job was performed, but the carriage ran with no ink ejected from the nozzles of the corresponding ink jet head thereon.

After a cleaning operation was run three times, the number of nozzles that failed to eject ink was counted. One gram of ink was discharged from the line of nozzles per run of cleaning. The line of nozzles was formed by 360 nozzles. Recovery from clogging was assessed according to the criteria below, with the results presented in Tables 3 to 5. The percentages are based on the total number of nozzles intentionally clogged.

A: No nozzle failed to eject ink.

B: Less than 3% of the nozzles failed to eject ink.

C: The percentage of nozzles that failed to eject ink was 3% or more and less than 5%.

D: The percentage of nozzles that failed to eject ink was 5% or more.

### 3.2.4. Static Stability (Potential for Wax Separation)

The water-based ink composition assigned to the Example or Comparative Example was put into three aluminum bags, with 100 g of ink in each bag. The bags were placed in CF9RX centrifuge (model number, Hitachi Koki Co., Ltd.) and spun at 500 rpm for 120 hours. The inks in the bags were then (1) allowed to stand, (2) stirred by shaking with 10 to-and-fro motions, or (3) stirred by shaking with 30 to-and-fro motions. Then the water-based ink compositions in the bags were visually inspected for wax separation. The wax floats on the surface of the water-based ink composition when it separates out. Static stability was graded according to the criteria below, with the results presented in Tables 3 to 5.

A: The wax did not separate out even when the ink was allowed to stand.

B: The wax separated out when the ink was allowed to stand, but did not when the ink was stirred by shaking with 10 to-and-fro motions.

C: The wax separated out when the ink was stirred by shaking with 10 to-and-fro motions, but did not when the ink was stirred by shaking with 30 to-and-fro motions.

D: The was separated out even when the ink was stirred by shaking with 30 to-and-fro motions. The ink did not recover from wax separation.

### 3.2.5. Damage to Medium

Using the modified SC-S40650, a solid image was printed on the recording medium with the water-based ink composition assigned to the Example or Comparative Example. In Examples 14 to 17, the assigned set of a water-based ink composition and a treatment liquid was used. After secondary heating, the printed article was visually inspected.

A: Heat caused no deformation.

B: Heat caused a certain degree of deformation.

C: Heat caused a significant degree of deformation.

TABLE 3

| | Example | | Example | | Example | | Example | | Example | | Example | | Example | | Example | | Example | | Example | | Example | |
|---|---|---|---|---|---|---|---|---|---|---|---|---|---|---|---|---|---|---|---|---|---|---|
| | 1 | | 2 | | 3 | | 4 | | 5 | | 6 | | 7 | | 8 | | 9 | | 10 | | 11 | |
| Treatment | — | | — | | — | | — | | — | | — | | — | | — | | — | | — | | — | |
| liquid | | | | | | | | | | | | | | | | | | | | | | |
| Ink | Ink A | | Ink C | | Ink D | | Ink E | | Ink F | | Ink G | | Ink H | | Ink I | | Ink J | | Ink K | | Ink A | |
| Recording | M1 | | M1 | | M1 | | M1 | | M1 | | M1 | | M1 | | M1 | | M1 | | M1 | | M2 | |
| medium | | | | | | | | | | | | | | | | | | | | | | |
| Secondary | IR | | IR | | IR | | IR | | IR | | IR | | IR | | IR | | IR | | IR | | IR | |
| heating | | | | | | | | | | | | | | | | | | | | | | |
| Temperature | 90.0° | C. | 90.0° | C. | 90.0° | C. | 90.0° | C. | 90.0° | C. | 90.0° | C. | 90.0° | C. | 90.0° | C. | 90.0° | C. | 90.0° | C. | 90.0° | C. |
| for secondary | | | | | | | | | | | | | | | | | | | | | | |
| heating* | | | | | | | | | | | | | | | | | | | | | | |
| Duration of | 40.0 | sec | 40.0 | sec | 40.0 | sec | 40.0 | sec | 40.0 | sec | 40.0 | sec | 40.0 | sec | 40.0 | sec | 40.0 | sec | 40.0 | sec | 40.0 | sec |
| secondary | | | | | | | | | | | | | | | | | | | | | | |
| heating** | | | | | | | | | | | | | | | | | | | | | | |
| Print | 40.0° | C. | 40.0° | C. | 40.0° | C. | 40.0° | C. | 40.0° | C. | 40.0° | C. | 40.0° | C. | 40.0° | C. | 40.0° | C. | 40.0° | C. | 40.0° | C. |
| temperature | | | | | | | | | | | | | | | | | | | | | | |

| | | | | | | | | | | | |
|---|---|---|---|---|---|---|---|---|---|---|---|
| Abrasion | A | B | AA | A | B | C | AA | B | A | B | B |
| resistance | | | | | | | | | | | |
| Recovery from | B | B | C | C | B | C | C | A | B | A | B |
| clogging | | | | | | | | | | | |
| Static | C | B | C | A | C | C | C | C | C | C | C |
| stability | | | | | | | | | | | |
| Damage to | A | A | A | A | A | A | A | B | A | A | A |
| medium | | | | | | | | | | | |

*Temperature for heating: The peak temperature the medium surface reached
**Duration of heating: The period of time for which the recording medium was at 80.0° C. or above

TABLE 4

| | Example | | Example | | Example | | Example | | Example | | Example | | Example | | Example | | Example | | Example | |
|---|---|---|---|---|---|---|---|---|---|---|---|---|---|---|---|---|---|---|---|---|
| | 12 | | 13 | | 14 | | 15 | | 16 | | 17 | | 18 | | 19 | | 20 | | 21 | |
| Treatment | — | | — | | Treatment | | Treatment | | Treatment | | Treatment | | — | | — | | — | | — | |
| liquid | | | | | liquid A | | liquid B | | liquid C | | liquid A | | | | | | | | | |
| Ink | Ink C | | Ink A | | Ink A | | Ink A | | Ink A | | Ink J | | Ink A | | Ink F | | Ink A | | Ink A | |
| Recording | M2 | | M1 | | M1 | | M1 | | M1 | | M1 | | M1 | | M1 | | M1 | | M1 | |
| medium | | | | | | | | | | | | | | | | | | | | |
| Secondary | IR | | IR + Air | | IR | | IR | | IR | | IR | | IR | | IR | | IR | | IR | |
| heating | | | | | | | | | | | | | | | | | | | | |
| Temperature | 90.0° | C. | 90.0° | C. | 90.0° | C. | 90.0° | C. | 90.0° | C. | 90.0° | C. | 90.0° | C. | 90.0° | C. | 100.0° | C. | 90.0° | C. |
| for secondary | | | | | | | | | | | | | | | | | | | | |
| heating* | | | | | | | | | | | | | | | | | | | | |
| Duration of | 40.0 | sec | 40.0 | sec | 40.0 | sec | 40.0 | sec | 40.0 | sec | 40.0 | sec | 30.0 | sec | 60.0 | sec | 80.0 | sec | 40.0 | sec |
| secondary | | | | | | | | | | | | | | | | | | | | |
| heating** | | | | | | | | | | | | | | | | | | | | |
| Print | 40.0° | C. | 40.0 ° | C. | 40.0° | C. | 40.0° | C. | 40.0° | C. | 40.0° | C. | 40.0° | C. | 40.0° | C. | 40.0° | C. | 35.0° | C. |
| temperature | | | | | | | | | | | | | | | | | | | | |

| | | | | | | | | | | |
|---|---|---|---|---|---|---|---|---|---|---|
| Abrasion | C | AA | B | B | A | C | B | A | AA | A |
| resistance | | | | | | | | | | |
| Recovery from | B | B | B | B | C | B | B | B | B | A |
| clogging | | | | | | | | | | |
| Static | B | C | C | C | C | C | C | C | C | C |
| stability | | | | | | | | | | |
| Damage to | A | A | A | A | A | A | A | A | B | A |
| medium | | | | | | | | | | |

*Temperature for heating: The peak temperature the medium surface reached
**Duration of heating: The period of time for which the recording medium was at 80.0° C. or above

TABLE 5

| | Comparative | | Comparative | | Comparative | | Comparative | |
|---|---|---|---|---|---|---|---|---|
| | Example 1 | | Example 2 | | Example 3 | | Example 4 | |
| Treatment liquid | — | | — | | — | | — | |
| Ink | Ink L | | Ink B | | Ink A | | Ink A | |
| Recording medium | M1 | | M1 | | M1 | | M1 | |
| Secondary heating | IR | | IR | | Hot air | | Conduction | |
| Temperature for | 90.0° | C. | 90.0° | C. | 90.0° | C. | 90.0° | C. |
| secondary heating* | | | | | | | | |
| Duration of | 40.0 | sec | 40.0 | sec | 45.0 | sec | 40.0 | sec |
| secondary heating** | | | | | | | | |
| Print temperature | 40.0° | C. | 40.0° | C. | 40.0° | C. | 40.0° | C. |

| | | | | |
|---|---|---|---|---|
| Abrasion resistance | AA | D | D | D |
| Recovery from clogging | D | A | B | B |
| Static stability | C | A | C | C |
| Damage to medium | A | A | B | C |

*Temperature for heating: The peak temperature the medium surface reached
**Duration of heating: The period of time for which the recording medium was at 80.0° C. or above

### 3.3. Test Results

In the Examples, the water-based ink composition used contained resin particles and wax. The volume-average diameter A of the resin particles was not less than 90.0 nm, and the ratio between the volume-average diameter A of the resin particles and the volume-average diameter B of the particles of the wax (B/A) was not less than 0.7. The heating step, moreover, was through irradiation with infrared light. As a result, all Examples achieved strong abrasion resistance and quick recovery from clogging.

The Comparative Examples, which were contrary to the Examples in any of the above conditions, were worse in abrasion resistance or recovery from clogging. Further details are as follows.

A comparison of Example 1 versus 3 indicates that abrasion resistance was stronger with smaller average diameter of the resin particles. Recovery from clogging was quicker with larger average diameter of the resin particles.

A comparison of Example 1 versus 2 or Example 1 versus 4 indicates that abrasion resistance was stronger with larger average diameter of the particles of the wax. Static stability was higher with smaller average diameter of the particles of the wax.

A comparison of Example 1 versus 6 indicates that abrasion resistance and recovery from clogging were better with higher melting point of the wax.

A comparison of Example 1 versus 13 indicates that abrasion resistance improved when a combination of infrared light and air was used in the heating step.

A comparison of Example 14 versus 17 indicates that abrasion resistance was stronger with a nonionically dispersed wax when a treatment liquid was used.

A comparison of Example 1 versus 18 indicates that abrasion resistance was stronger with longer duration of secondary heating.

A comparison of Example 1 versus 20 indicates that abrasion resistance was stronger with higher temperature for secondary heating. Damage to medium was smaller with lower temperature for secondary heating.

A comparison of Example 1 versus 21 indicates that recovery from clogging was quicker with lower print temperature.

Comparative Example 1 indicates that recovery from clogging was slow when the volume-average diameter of the resin particles was less than 90 nm.

Comparative Example 2 indicates that abrasion resistance was weak when the particle-diameter ratio was less than 0.7.

Comparative Examples 3 and 4 indicate that abrasion resistance was weak when the heating step was performed without infrared light.

The present disclosure is not limited to the above embodiments, and many variations are possible. For example, the present disclosure embraces configurations substantially identical to those described in the embodiments (e.g., configurations identical in function, methodology, and results to or having the same goal and offering the same advantages as the described ones). The present disclosure also includes configurations created by changing any nonessential part of those described in the above embodiments. Furthermore, the present disclosure encompasses configurations identical in operation and effect to or capable of fulfilling the same purposes as those described in the above embodiments. Configurations obtained by adding any known technology to those described in the embodiments are also part of the present disclosure.

What is claimed is:

1. An ink jet recording method comprising:
an ink attachment step, in which a water-based ink composition is ejected from an ink jet head and attached to a recording medium; and
a heating step, in which the recording medium is heated, after the ink attachment step, wherein:
the water-based ink composition contains resin particles and wax;
the resin particles have a volume-average diameter A of 90.0 nm or more;
a ratio between the volume-average diameter A of the resin particles and a volume-average diameter B of particles of the wax, B/A, is 0.7 or more; and
the heating step is through irradiation with infrared light.

2. The ink jet recording method according to claim 1, wherein:
the volume-average diameter A of the resin particles is 150.0 nm or more and 300.0 nm or less; and
the volume-average diameter B of the particles of the wax is 60.0 nm or more and 300.0 nm or less.

3. The ink jet recording method according to claim 1, wherein
the ratio B/A is 0.7 or more and 2.5 or less.

4. The ink jet recording method according to claim 1, wherein
the resin particles have a glass transition temperature of 60.0° C. or more and 90.0° C. or less.

5. The ink jet recording method according to claim 1, wherein
the wax has a melting point of 105.0° C. or more and 140.0° C. or less.

6. The ink jet recording method according to claim 1, wherein
in the heating step, the recording medium is heated to a surface temperature equal to or higher than a glass transition temperature of the resin particles and lower than a melting point of the wax.

7. The ink jet recording method according to claim 1, wherein
the wax is a polyolefin wax.

8. The ink jet recording method according to claim 1, wherein
the heating step includes moving air present around the recording medium using an air-blow mechanism.

9. The ink jet recording method according to claim 1, wherein
the resin particles are of a resin selected from acrylic resins, urethane resins, ester resins, and vinyl chloride resins.

10. The ink jet recording method according to claim 1, wherein:
the resin particles represent 0.5% by mass or more and 15.0% by mass or less of a total mass of the ink composition; and
the wax represents 0.1% by mass or more and 2.0% by mass or less of the total mass of the ink composition.

11. The ink jet recording method according to claim 1, wherein
in the heating step, a portion of the recording medium has a surface temperature of 80.0° C. or above for a period of 20.0 seconds or more and 120.0 seconds or less.

12. The ink jet recording method according to claim 1, further comprising
attaching a treatment liquid containing a flocculant to the recording medium.

13. The ink jet recording method according to claim 1, wherein
the wax is a nonionically dispersed wax.

14. The ink jet recording method according to claim 1, wherein
the water-based ink composition contains an organic solvent having a normal boiling point of 180.0° C. or more and 280.0° C. or less, with the organic solvent representing 20.0% by mass or more and 35.0% by mass or less.

15. An ink jet recording apparatus configured to perform the ink jet recording method according to claim 1.
